(19) United States
(12) Patent Application Publication
(10) Pub. No.: US 2015/0296450 A1
(43) Pub. Date: Oct. 15, 2015

(54) METHOD AND APPARATUS FOR CONTROLLING SWITCHING OF CONNECTION TO AN ACCESS POINT OF A WIRELESS NETWORK BASED ON INFORMATION OF ACCESS POINTS OF THE NETWORK

(71) Applicant: AIRPLUG INC., Sopang-gu Seoul (KR)

(72) Inventors: Jun Mo Koo, Uiwang-si (KR); Seung Jun Lee, Seoul (KR); Sang Kug Yi, Gwangju-si (KR); Soon Uk Kim, Anyang-si (KR)

(21) Appl. No.: 14/442,869

(22) PCT Filed: Feb. 14, 2013
(86) PCT No.: PCT/KR2013/001150

§ 371 Date: May 14, 2015

(30) Foreign Application Priority Data
Nov. 20, 2012 (KR) 10-2012-0131509

(51) Int. Cl. H04W 48/20; H04W 48/16

(52) U.S. Cl. CPC H04W 48/20; H04W 48/16

(57) ABSTRACT

A wireless communication terminal according to the present invention, if it is found that an access point (AP) is available from searching a wireless communication network, for example, a Wi-Fi network, checks whether the AP is registered in a list of delayed access points. If the access point in included in the list of delayed access points, the wireless communication terminal re-searches the Wi-Fi network after a predetermined waiting time is passed. If the AP is unavailable, connection to a current mobile communication network is maintained whereas, if the AP is still available, the wireless communication terminal switches connection from a mobile communication network to the AP. If not registered in a list of delayed access points, the wireless communication terminal immediately switches connection from a mobile communication network to the AP without the waiting time.

### TECHNICAL FIELD

The present invention is related to a method for a wireless communication terminal to selectively switch its connection state to a wireless communication network while a plurality of wireless communication networks can be accessed selectively and an apparatus for the method.

### BACKGROUND ART

As mobile communication networks are advanced, users are now able to enjoy various kinds of information and contents for their needs through data services provided by the mobile communication networks regardless of their current location by using a wireless communication terminal such as a smart phone, tablet computer, and the like, not to mention a mobile phone.

To use a data service through a mobile communication network, a mobile terminal (MT) has to receive necessary information from GPRS (General Packet Radio Service) resources (in what follows, they are called a “GPRS network”) implemented in the mobile communication network. One example of the aforementioned procedure is illustrated in FIG. 1, which is based on a GPRS network implemented in the 3G mobile communication network. In the illustrated procedure, a signaling signal, intended for generating and/or notifying PDP context (which includes PDP type, PDP address type, QoS request/negotiation profile, certification type, and DNS type) used for connection between a serving GPRS support node (SGSN) and a gateway GPRS support node (GGSN) in response to a PDP context activation request S01 of a mobile terminal (MT) is generated in a GPRS network side S02, S03; if PDP context is successfully allocated, a response including an IP address to which the SGSN is allocated is transmitted to the MT S04. After information carried by the transmitted response is set, the MT enters a data service connection state (in what follows, the state is called “connection” for short) for a mobile communication network; afterwards, the MT is enabled to use a data service by using the IP address.

Meanwhile, in the case of information or contents containing a large amount of data, users tend to access the information or contents by accessing a high-speed wireless data network, for example, Wi-Fi wireless LAN (hereinafter, it is called “Wi-Fi network” for short and the Wi-Fi network is assumed to represent a wireless data network); in other cases, the users tend to use a mobile communication network, for example, a cellular mobile communication network (such as 3G or 4G-based mobile phone communication network). This tendency results from a current situation that a Wi-Fi network provides the users with a communication infrastructure free of charge but available only in a relatively narrow area.

As mentioned above, since Wi-Fi networks are sparsely deployed and available only for limited, narrow areas, users do not know exactly at which place in which area they can access the Wi-Fi network. In this reason, most of the users set Wi-Fi network access of their wireless communication terminal to “auto mode”. A wireless communication terminal in “auto mode” periodically searches the surroundings for a Wi-Fi network available and performs access to the Wi-Fi network found; an IP address needed for data services is then obtained and set up for the wireless communication terminal.

Prior to accessing the Wi-Fi network, an IP address allocated from a conventional cell-based mobile communication network (hereinafter, it is called a “cellular network”) is set up for the wireless communication terminal. When the wireless communication terminal accesses the Wi-Fi network, connection to the cellular network is released. During this operation, the GPRS network carries out operation of releasing resources or set-up information allocated for the wireless communication terminal to establish connection to data services. One example of the procedure above is illustrated in FIG. 2. In the illustrated procedure, a signaling signal for releasing PDP context used for connection between the SGSN and the GGSN is generated in the GPRS network S12, S13 and a message is then delivered to the MT, notifying of release of the connection S14.

As described above, since a signal exchange procedure is carried out for establishing and releasing connection to a cellular network for data services as illustrated in FIGS. 1 and 2, frequent establishment and release of connection to a mobile communication network may impose a significant burden on the network due to subsequent signal exchange. Moreover, in case release of connection is attempted while no actual data service has been used since connection to the cellular network, signaling signals as illustrated in FIGS. 1 and 2 are generated in vain from a viewpoint of users as well as mobile communication service providers, leading to waste of communication resources.

The frequent connection/release or connection/release without involving actual use of a data service mentioned above may occur while people are moving around. For example, as shown in FIG. 3, in case an access point (AP) of a Wi-Fi network is installed at a station of public transportation means such as bus, subway, and the like; and passengers of the public transportation means carrying a wireless communication terminal get off at the station and move toward their destination la, they soon enter the service zone 10 of the access point AP1 installed at the place. In this case, each individual wireless communication terminal of the people, being connected to a cellular network while they are moving in a public transportation means, detects the access point (AP1) of the place as they passes the service zone 10 and connection switching to a Wi-Fi network is initiated. However, if the user does not stay at the station but leaves the service zone 10 of the corresponding access point AP1, connection to the Wi-Fi network is maintained only for a short duration of time and the corresponding wireless communication terminals are again connected to the cellular network.

As can be seen from the above case, connection to a cellular network is preserved after all; due to temporary access to a Wi-Fi network, a signaling signal for connection release as shown in FIG. 2 and a signaling signal for re-connection to the cellular network due to the connection release as shown in FIG. 1 are generated in vain. In particular, in case a large number of people get off at a station equipped with an access point, for example, in case a large number of people get off subway cars inside which access points to a Wi-Fi network are not provided (in this particular case, all of the mobile terminals within the corresponding subway cars remain to be connected to a cellular network), a large amount of traffic of signaling signals are imposed upon the GPRS network during the procedure of re-connection to and release from the cellular network within a short period of time, resulting in a unnecessary load to communication resources. In addition, the unnecessary traffic renders previous connection to the Wi-Fi network useless and a signaling signal generated from the undesirable connection can give rise to temporary congestion for wireless communication terminals using the access point at the corresponding station to use a data service.

Furthermore, for individual people passing by the place such as a station equipped with an access point, a time period for a data service for their mobile terminal is actually reduced due to connection switching/re-switching to the access point of the place. And this is caused by an excessive period of time wasted for connection switching during which data services are unavailable. Moreover, in case a user moves around while using a data service, seamless information reception is not guaranteed because of connection switching/re-switching and thus screen display is lost or delayed due to re-request after connection switching or re-connection, making user experience (UX) degraded. In addition, since notification state of the screen of the mobile terminal changes rapidly according to the connection switching/re-switching, users are made to unnecessarily pay attention to the notification, which also undermine user experience.

### DISCLOSURE

### Technical Problem

One object of the present invention is to provide a method and apparatus for preventing unnecessary connection switching of a wireless communication terminal.

Another objective of the present invention is to provide a method and apparatus for configuring connection management information about access points of a wireless communication network detected according as a wireless communication terminal moves.

Yet another objective of the present invention is to provide a method for controlling connection switching for improving connectivity of a wireless communication terminal to a wireless communication network and an apparatus for the method.

Still another objective of the present invention is to provide a method for controlling connection switching for reducing a load of signaling signals due to connection to and release from communication resources providing a data service in a mobile communication network and an apparatus for the method.

The scope of the present invention is not necessarily limited to the above explicit statements. Rather, the scope of the present invention covers anything to accomplish effects that could be derived from the below specific and illustrative explanations of the present invention.

### Technical Solution

According to one aspect of the present invention, a wireless communication terminal capable of using a data service provided by a wireless communication network comprises: an information acquisition unit configured to search the wireless communication network for an available access point; and a connection management unit configured to either carry out a delayed selective connection switching operation or cause connection of the wireless communication terminal to be switched to the available access point, based on whether the available access point is listed in a pre-specified access point list, if the information acquisition unit discovers that an access point of the wireless communication network is available. The delayed selective connection switching operation comprises: a first operation of re-searching the wireless communication network after a predetermined waiting time; and a second operation of keeping the wireless communication terminal in a current connection state in case it is found from the re-searching that the access point is unavailable, and of causing connection of the wireless communication terminal to be switched to the access point in case the access point is found to be available.

In one embodiment of the present invention, the connection management unit is configured to carry out the delayed selective connection switching operation if the access point is registered in the access point list.

In another embodiment of the present invention, the connection management unit is configured to carry out the delayed selective connection switching operation if the access point is not registered in the access point list.

In one embodiment of the present invention, the connection management unit is configured to set the waiting time by using a time value assigned to the access point identified by the information acquisition unit.

In one embodiment of the present invention, the connection management unit is configured to set the waiting time in such a manner that the waiting time is shorter as signal strength of the access point is higher, the signal strength being detected by the information acquisition unit.

In one embodiment of the present invention, the connection management unit is further configured to obtain data usage for another wireless communication network of the wireless communication terminal, and to set the waiting time in such a manner that the waiting time is shorter as the data usage is greater.

In one embodiment of the present invention, the connection management unit is further configured to obtain from an external server information indicating a current load on a service area of another wireless communication network, the service area being where the wireless communication terminal is located, and to set the waiting time in such a manner that the waiting time is shorter as the current load indicated by the obtained information is higher.

In one embodiment of the present invention, the delayed selective connection switching operation may further comprise: an operation of constructing display of the wireless communication terminal, once the predetermined waiting time gets started, through which a user requests a connection to the wireless communication network; and an operation of switching connection of the wireless communication terminal to the wireless communication network regardless of whether the waiting time expires, if a connection request is made by a user.

In one embodiment of the present invention, the connection management unit, while carrying out the second operation, determines that the access point is unavailable if the access point is not found from the re-searching or shows signal strength not greater than a predetermined threshold level.

In one embodiment of the present invention, the connection management unit is further configured to obtain from an external server a time value for delaying determination on whether to connect, and to set the obtained time value to the waiting time, the time value being to be applied for current time or a service area of another wireless communication network, wherein the service area is where the wireless communication terminal is located.

In one embodiment of the present invention, the delayed selective connection switching operation may further comprises an operation of, if another access point rather than the access point showing signal strength greater than a predetermined threshold level is found from the re-searching, checking whether the another access point is registered in the access point list, and according to the checking result, delaying determination on whether to connect to the another access point or switching connection of the wireless communication terminal from another wireless communication network to the another access point.

In one embodiment of the present invention, the connection management unit is configured to further conduct, if the wireless communication terminal is released from a one access point of the wireless communication network after being connected thereto, acquiring connection hold time with the one access point and registering the one access point in the access point list or removing the one access point from the access point list, based on information computed from one or more connection hold times acquired for the one access point. In this embodiment, the information computed from the one or more connection hold times may be an average value of the one or more connection hold times or a ratio of number of connection hold times, each being less than or greater than a predetermined threshold time, to a total number of connection hold times used in the computing. The connection management unit, in registering the one access point in the access point list, determines a time value for delaying determination on whether to connect from the one or more connection hold times and sets the time value to be used as the waiting time for the one access point. In addition, the connection management unit may construct display of the wireless communication terminal, through which a user selects whether to register the one access point, prior to registering the one access point in the access point list, and register the one access point in the access point list if a user selects registration.

In another embodiment of the present invention, the connection management unit is configured to set up the access point list by receiving the access point list from an external server. In this embodiment, the connection management unit may be further configured to provide the external server with location information from which a location of the wireless communication terminal is identifiable, and access points registered in the access point list received from the external server in response to provision of the location information are ones located inside an area having a predetermined size including the location or located along a predetermined route.

In still another embodiment of the present invention, the connection management unit may be configured to prepare or update the access point list based on access point information entered by a user. In such configuration, if a user requests registration of a new access point into the access point list, the connection management unit may display on a screen of the wireless communication terminal information about access points, which the wireless communication terminal has been recently connected to, and thus enable a user to select an access point to register newly.

In one embodiment of the present invention, the connection management unit is configured to carry out the delayed selective connection switching operation or cause connection to be switched to the access point based on whether the access point is listed in the access point list, only if present time pertains to an applicable time zone of the access point list. In this embodiment, the access point list may consist of a plurality of access point lists each of which having a different applicable time zone, and time values for delaying determination on whether to connect to an access point are assigned respectively for the plurality of access point lists, the time values being assigned differently among at least two individual lists of the plurality of access point lists. In the case that the plurality of access point lists are used, the connection management unit checks whether the access point is registered in one individual list an applicable time zone of which includes present time, and uses a time value assigned to the one individual list as the waiting time when carrying out the delayed selective connection switching operation according to a result of the checking.

In one embodiment of the present invention, the connection management unit is configured to: carry out the delayed selective connection switching operation or cause connection to be switched to the access point based on whether the access point is listed in the access point list in case application of the access point list is demanded by an external server; and switch connection of the wireless communication terminal from another wireless communication network to the access point regardless of whether the access point is listed in the access point list in case application of the access point list is not demanded. In this embodiment, the connection management unit is further configured to receive a command on whether to apply the access point list while providing the external server with location information from which location of the wireless communication terminal is identifiable.

In another embodiment of the present invention, the information acquisition unit is further configured to obtain identification information of a service cell of another wireless communication network, the service cell being where the wireless communication terminal is located, and the connection management unit is configured to: carry out the delayed selective connection switching operation or cause connection to be switched to the access point based on whether the access point is listed in the access point list in case identification information of a recent service cell obtained by the information acquisition unit is included in a predetermined cell list; and switch connection of the wireless communication terminal from another wireless communication network to the access point regardless of whether the access point is listed in the access point list in case the identification information of the recent service cell is not included in the predetermined cell list.

In one embodiment of the present invention, the connection management unit can be further configured to deactivate a particular mode (e.g., auto-mode) at startup if the wireless communication terminal has been set to the particular mode for accessing to the wireless communication network in which the wireless communication terminal automatically searches for an access point and subsequently connects to a found access point.

In one embodiment of the present invention, the information acquisition unit and the connection management unit are configured to operate while a predetermined condition is met and remain in an idle state while the condition is not met, wherein the predetermined condition corresponds to: a condition on whether present time belongs to a predetermined time zone; a condition on whether the wireless communication terminal is in a screen unlock state; or a condition on whether a mode for accessing the wireless communication network set in the wireless communication terminal is an auto-mode designated by a user.

According to another aspect of the present invention, a wireless communication terminal capable of using a data service provided by a wireless communication network comprises, instead of the connection management unit, a second connection management unit, if an access point is found to be available by the information acquisition unit in a state that the wireless communication terminal is not connected to the wireless communication network, configured to cause the wireless communication terminal to be connected to the access point after setting connection of the wireless communication terminal not to be released from another wireless communication network, and carry out a delayed selective connection release operation or cause connection state to the another wireless communication network to be released, based on whether the access point is listed in a pre-specified access point list, wherein the delayed selective connection release operation comprises: an operation of checking whether the access point is available after a predetermined waiting time elapses; and an operation of causing connection state to be released from the another wireless communication network in case the access point is found to be available.

According to still another aspect of the present invention, a wireless communication terminal capable of using a data service provided by a wireless communication network, comprises, instead of the connection management unit, a third connection management unit, if an access point is found to be available by the information acquisition unit in a state that the wireless communication terminal is not connected to the wireless communication network, configured to carry out a delayed selective connection release operation or cause connection of the wireless communication terminal to be switched to the access point, based on whether the access point is listed in a pre-specified access point list, wherein the delayed selective connection release operation comprises: an operation of causing the wireless communication terminal to be connected to the access point after setting connection of the wireless communication terminal not to be released from another wireless communication network; an operation of checking whether the access point is available after predetermined waiting time elapses; and an operation of causing connection state to be released from the another wireless communication network in case the access point is found to be available.

In one embodiment of the present invention, the second management unit and the third one, in the operation of checking, determines the access point to be available if the wireless communication terminal is connected to the wireless communication network or signal strength of the access point is greater than a predetermined threshold level after the waiting time.

According to still another aspect of the present invention, a method for controlling connection switching for a plurality of wireless communication networks comprises: a first step of searching a wireless communication network; a second step of checking whether an access point of the wireless communication network is listed in a pre-specified access point list if the access point is found to be available from the searching; and a third step of re-searching the wireless communication network after a predetermined waiting time if the access point is or is not listed in the access point list, and either keeping a wireless communication terminal in a current connection state in case it is found from the re-searching that the access point is unavailable, or causing connection of the wireless communication terminal to be switched to the access point in case the access point is found to be available.

According to still another aspect of the present invention, an apparatus equipped with a storage storing for programs comprises: communication means being capable of transceiving data through communication with an outside entity; and storing means storing an application to be run on a wireless communication terminal, the application being transmitted or received through the communication means. The application includes program codes to accomplish functions, in case of being run on the wireless communication terminal, that comprise: searching a wireless communication network for an available access point; and in case an access point of the wireless communication network is found to be available, carrying out a delayed selective connection switching operation or causing connection of the wireless communication terminal to be switched from another wireless communication network to the access point, based on whether the access point is listed in a pre-specified access point list, wherein the delayed selective connection switching operation comprises: re-searching the wireless communication network after a predetermined waiting time; and either keeping the wireless communication terminal in a current connection state in case it is found from the re-searching that the access point is unavailable, or causing connection of the wireless communication terminal to be switched to the access point in case the access point is found to be available.

In the aforementioned wireless communication terminals, methods, and apparatus, the wireless communication terminal is currently connected to another wireless communication network or another access point of the wireless communication network rather than the access point.

In the aforementioned wireless communication terminals, methods, and apparatus, the another wireless communication network is a mobile network supporting handover between service cells, and the wireless communication network is a network such as Wi-Fi network constituted by access points distributed and individually providing a data service in each service cell that covers an area narrower than an average size of a single service cell of the another wireless communication network.

### Advantageous Effects

The present invention described above or at least one embodiment of the present invention described in detail below with reference to appended drawings prepares a particular list of access points installed at bus stops, stations, etc. of public transportation means (bus, subway, and so on) or along the roadside (or a particular list of access points installed in places other than the aforementioned spots) and thus prevents unnecessary connection release from and re-connection to a cellular network based on a decision whether an access point is (or is not) included in the particular list in case a user passes by the access point of a Wi-Fi network while the user moves being connected to the cellular network. Therefore, the load, which is usually imposed on communication resources intended for providing data services in a cellular network, is considerably reduced; thus mobile communication service providers can manage communication resources more efficiently, thereby reducing costs for operating a communication network.

Also, according to embodiments of the present invention, where switching to an access point found is delayed if the access point is (or is not) included in a particular list, connection switching to the access point is prevented, thus improving user experience of a wireless communication terminal and connectivity thereof. In other words, avoided is a situation due to unnecessary change of connection state about an access point, which in most cases, is easily passed by, where visual information displayed on the screen of a mobile terminal is lost or repeated or unnecessarily draws the user's attention; furthermore, a connection period of time during which a data service can be used is actually reduced by a transitional state due to connection switching. A transitional state due to connection switching makes power consumption go higher; by reducing occurrence of such a transitional state, battery life of a wireless communication terminal can be extended.

### DESCRIPTION OF DRAWINGS

FIGS. 1 and 2 illustrate a signaling signal exchange procedure carried out according to connection for using a data service and releasing the connection in the 3G mobile communication network;

FIG. 3 illustrates an example of user movement at a station where a public transportation means stops;

FIG. 4 illustrates a block diagram of a wireless communication terminal in which implemented is a method for controlling connection switching to and from an access point of a wireless communication network based on access point information of the wireless communication network according to the present invention;

FIG. 5 illustrates a structure of a connection control agent carrying out an operation for controlling connection switching to an access point of a wireless communication network based on access point information of the wireless communication network and a relationship for signal exchange between the agent and its neighboring constituting elements according to one embodiment of the present invention;

FIGS. 6 and 7 are procedures carried out according to one embodiment of the present invention, including a procedure for checking an available access point in a Wi-Fi network and a procedure for selectively connecting to an access point checked;

FIG. 8 is a procedure for managing information of an access point list, based on which a decision is made whether to carry out delayed connection to a particular access point according to one embodiment of the present invention;

FIG. 9 is one example of a list of access points requiring delayed connection according to one embodiment of the present invention;

FIG. 10 is one example of a list of access points for each of which waiting time is assigned for delayed connection according to another one embodiment of the present invention;

FIG. 11 illustrates a structure of a variable for managing time information about connection to or release from access points in a Wi-Fi network and information contained therein to generate or update a list of access points for delayed connection according to one embodiment of the present invention;

FIG. 12 illustrates a procedure of determining a waiting time for an access point in registering the access point for a list of access points for delayed connection in an embodiment according to FIG. 10, where connection maintaining time determines the waiting time by which connection to the access point is delayed;

FIG. 13 is a graph illustrating one example of a rule based on which a time delay for connecting to an access point is dynamically determined by signal strength of the access point according to one embodiment of the present invention;

FIG. 14 is a procedure of checking the amount of data used in real time by checking the accumulated data usage of a wireless communication terminal according to one embodiment of the present invention;

FIG. 15 illustrates a structure of a list of access points for delayed connection according to another embodiment of the present invention along with the corresponding application time zones and a procedure through which the list is applied;

FIG. 16 illustrates a structure of a plurality of lists of access points for delayed connection according to yet another embodiment of the present invention along with the corresponding application time zones; and

FIGS. 17 and 18 illustrate the respective examples of a procedure for delaying connection release from a mobile communication network based on whether an access point in question is registered for a particular list according to another one embodiment of the present invention.

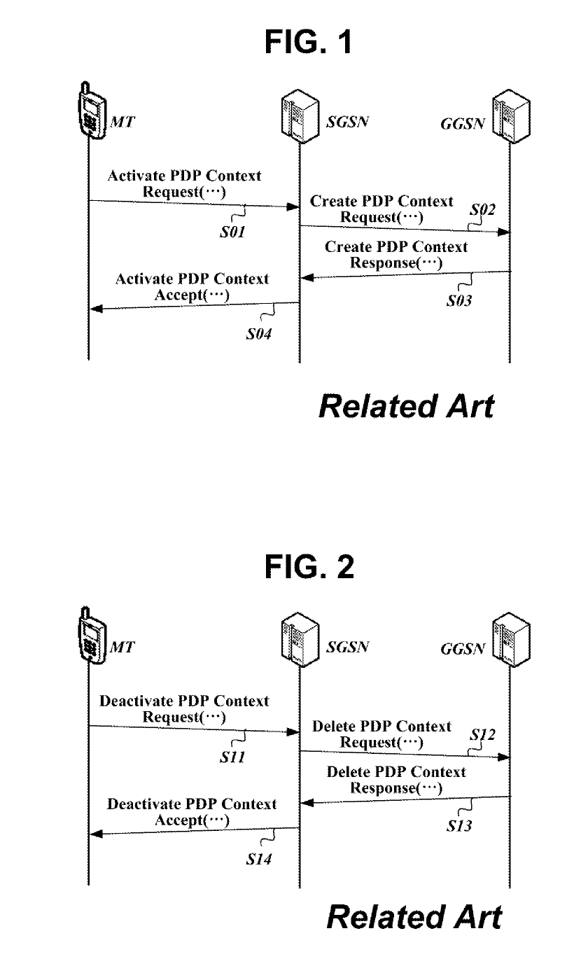

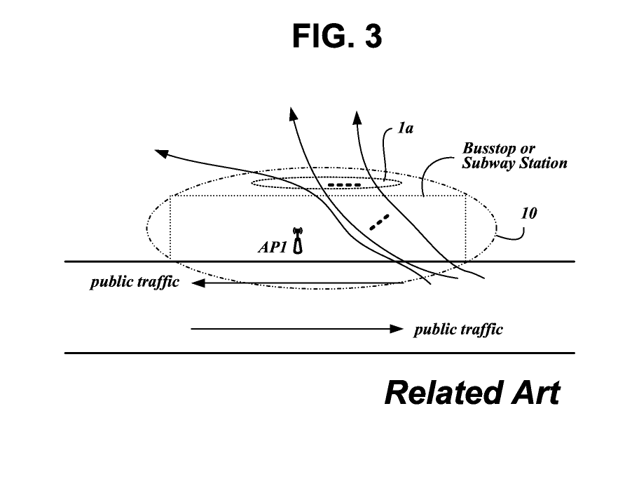

### MODE FOR INVENTION

In what follows, embodiments of the present invention will be described in detail with reference to appended drawings.

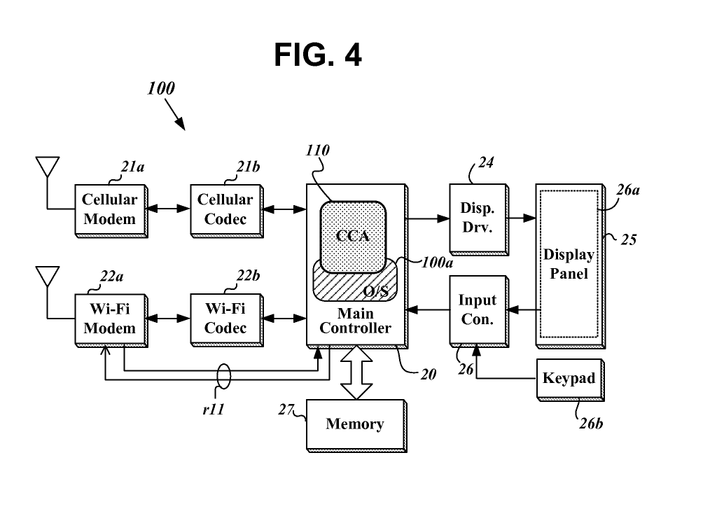

FIG. 4 illustrates a block diagram of a wireless communication terminal in which a method for controlling connection switching to a wireless communication network according to the present invention is implemented, where the terminal may correspond to one type of terminals including a smart phone capable of accessing various types of wireless communication networks, tablet computer, and notebook computer equipped with resources for a wireless communication function.

To provide specific descriptions of the block diagram in the figure, a wireless communication terminal comprises a cellular modem 21a (which is a constituting element including a module processing RF signals) communicating with a cellular network by modulating or demodulating a signal according to a predetermined method adopted for the cellular network; a cellular codec 21b encoding data or decoding encoded data according to communication protocols adopted for the cellular network; a Wi-Fi modem 22a communicating with a Wi-Fi network by modulating or demodulating signals according to a predetermined method adopted for the Wi-Fi network; a Wi-Fi codec 22b encoding data or decoding encoded data according to communication protocols adopted for the Wi-Fi network; a display panel 25 for visual display of an image, characters, and so on; a display driving unit 24 driving the display panel 25 for arbitrary data to be displayed visually on the display panel 25; a touch sensor 26a attached at the front of the display panel 25; a keypad 26b equipped with keys and/or buttons; an input control unit 26 sensing a user input and/or selection applied to the touch sensor 26a and keypad 26b; a main controller 20 communicating data with the constituting elements or controlling them to carry out operation according to input information from the input control unit 26 or controlling the display driving unit 24 for display of a user interface (UI) intended for receiving the user's selection; and a memory 27 providing data storage space required for operation of the main controller 20.

The main controller 20 executes command codes, which are contained in the firmware of the main controller 20, for operating system 100a to perform functions intended to drive hardware resources of the wireless communication terminal 100 and to perform exchange of signals and/or information between the corresponding resources. The operating system may be a conventional operating system such as Android, iOS, Windows, and so on or operating system providing functions dedicated to the present invention. The main controller 20 also executes the whole or part of command codes of a connection control agent 110 (CCA), where the CCA controls appropriate connection to the two types of wireless communication networks, namely, the cellular and Wi-Fi network by using an application program interface (API) provided by the operating system 100a. By executing the command codes of the CCA, the main controller 20 carries out functions of the CCA 110, which will be described in detail below.

The structure of the wireless communication terminal 100 illustrated in FIG. 4 is only an example intended to describe embodiments of the present invention in a specific and illustrative manner to help understand the technical principles and scope of the present invention. Mobile terminals implementing the technical principles of the present invention can further include constituting elements providing various functions not shown in FIG. 4 or exclude constituting elements illustrated and moreover, hardware elements can be implemented by software and vice versa.

The whole or part of the connection control agent 110 carries out the operation described below in the form of an application or a process implemented in the wireless communication terminal 100; software programs corresponding to the application or process can be provided by a particular application server equipped with a large capacity storage means and connected to a communication network through a communication means installed therein. In this case, the software recorded in the large capacity storage means of the application server through a conventional on-line purchase process is downloaded and installed into the memory 27 of the wireless communication terminal 100 and after installation, the software can be carried out depending on the needs or according to particular conditions. In some cases, constituting elements carrying out at least part of functions of the connection control agent 110 described in detail below can be installed beforehand in the wireless communication terminal 100 or in the main controller 20 in the form of middleware, platform based on which applications are executed, or part of the operating system 100a. In other cases, the connection control agent 110 includes hardware components which carry out part of the functions described in detail below. Therefore, the connection control agent 110, structure and operation method of which are different for various embodiments of the present invention, does not limit the technical scope of the present invention by particular types of implementations or resources employed for the connection control agent 110.

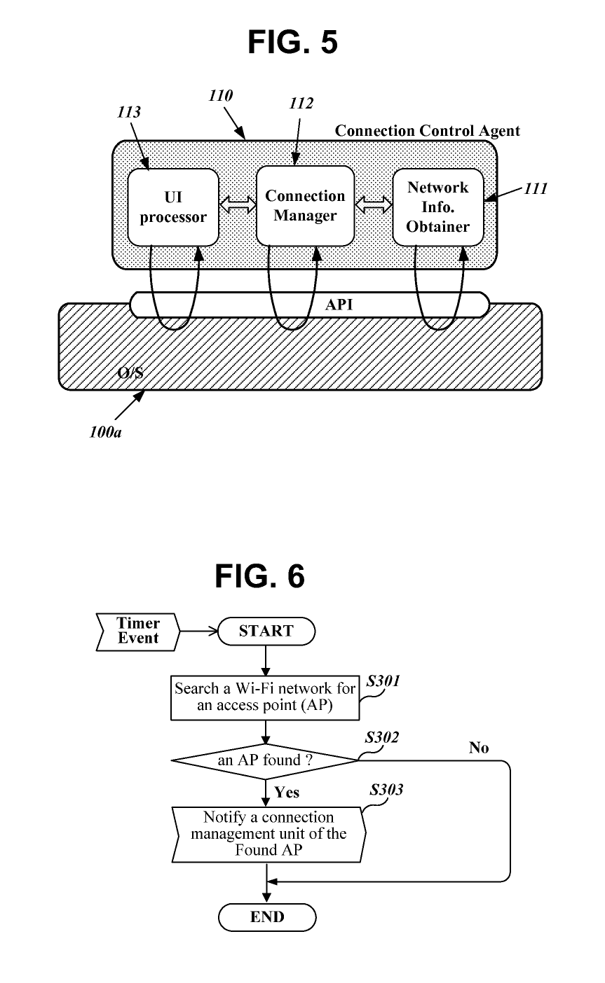

As shown in FIG. 5, the connection control agent 110 according to one embodiment of the present invention comprises a network information acquisition unit 111 by which the wireless communication terminal 100 searches a wireless communication network for necessary information; a connection management unit 112 setting up information for connection management about a Wi-Fi network and carrying out selective connection to an access point of the Wi-Fi network based on the information obtained from the network information acquisition unit 111; and a UI processing unit 113 displaying on the display panel 25 visual information required for a user or receiving information selected by the user. As shown in FIG. 5, the connection control agent 110, the network information acquisition unit 111, the connection management unit 112, or the UI processing unit 113, for the case of part of operation described in detail below, carries out the operation by requesting particular functions (for example, display of information or a menu, delivery of information input through an input means (the keypad 26b or touch sensor 26a), communication with external devices according to a protocol, checking communication status, checking hardware status, checking real-time operation, timer-related function, and so on) provided individually by hardware constituting components and the operating system 100a illustrated in FIG. 4 through an API provided by the operating system 100a.

In one embodiment of the present invention, the network information acquisition unit 111, the connection management unit 112, and the UI processing unit 113 may be implemented as separate processes operating on top of the operating system 100a. In other cases, the connection control agent 110 including the network information acquisition unit 111, the connection management unit 112, and the UI processing unit 113 may be implemented as a single process. In this case, information or data exchange among them can be carried out through global variables, internal variables, or arguments and/or return values of local functions, and the like. Therefore, the concept, technical principles, and objectives of the present invention do not necessarily require that the network information acquisition unit 111, the connection management unit 112, and the UI processing unit 113 should be implemented as separate processes; however, the concept, technical principles, and objectives of the present invention can also be realized for the case where all the functions of individual constituting elements 111, 112, 113 described below are integrated into the connection control agent 110 and implemented as a single process.

In what follows, described in detail will be a procedure for the connection control agent 110 structured as shown in FIG. 5 to control switching of connection to an access point in a wireless communication network, based on access point information of the wireless communication network used by the wireless terminal 100 structured as shown in FIG. 4.

The user of the wireless communication terminal 100, in response to a display screen displayed on the display panel 25, controls the display driving unit 24 and applies an appropriate input to the corresponding display screen through the keypad 26b or touch sensor 26a, thereby operating the connection control agent 110. In another embodiment of the present invention, the connection control agent 110 can be operated automatically according to predetermined conditions without involving a user request. For example, the connection control agent 110 can be configured to operate automatically if the current time corresponds to a predetermined, particular time zone (for example, morning and evening rush hour where movement of people is concentrated); at the moment the screen lock of the wireless communication terminal is released; or in case access to a Wi-Fi network is changed to “auto-mode”. As a matter of course, the main controller 20 determines a set-up for operating mode such as the above in an appropriate form through an operating environment set-up window provided on the display panel 25. In the present embodiment, the main controller 20 terminates execution of the connection control agent 110 if an opposite condition (for example, time beyond the particular time zone, screen lock state, the user's setting up the access mode as a “manual mode”, and so on) to the predetermined conditions is met.

Different from an embodiment where the connection control agent 110 is operated automatically, when the predetermined conditions are met, the connection control agent 110 initiates operation for controlling connection switching to and from a wireless communication network after the connection control agent 110 is activated in the wireless communication terminal 100; if the opposite condition is met, the connection control agent 110 may stop the control operation and enter an idle state.

If the connection control agent 110 is activated in the wireless communication terminal 100, the connection management unit 112 first inquires of the operating system 100a about access mode of a Wi-Fi network. In case it is found that the access mode is “auto-mode” set up by the user, the access mode is changed to “manual mode” or a function of automatic connection at the time of searching a Wi-Fi network is disabled. This mechanism is introduced to prevent the operating system 100a from carrying out connection switching to an arbitrary access point while searching the Wi-Fi network. In this way, after the access mode is changed to “manual mode” from “auto-mode” or the function of automatic connection is disabled, the connection management unit 112 notifies the UI processing unit 113 of such change. Upon receiving the notification, the UI processing unit 113 requests the operating system 100a (at this time, the UI processing unit 113 may provide a necessary icon image) to display a symbol, for example, an icon corresponding to the “auto-mode”, of an access mode for the Wi-Fi network on the display panel 25. In other words, although the operating system 100a actually accesses a Wi-Fi network manually (in other words, the Wi-Fi network allows limited access only when a request is issued by an application or process), the user is made to feel that the access mode for a current Wi-Fi network is set to the “auto-mode” according to the user's setting.

If the connection control agent 110 is activated, the network information acquisition unit 111 requests the operating system 100a to set up and at the same time, activate a timer required. The timer is intended for carrying out periodically a procedure of checking access points of a Wi-Fi network as shown in FIG. 6. If an activation request for the timer is received along with setting up the timer, the operating system 100a generates a time-out event along with identification information of the corresponding timer at the moment a time set up for the timer elapses, thereby making the network information acquisition unit 111 recognize the corresponding time lapse.

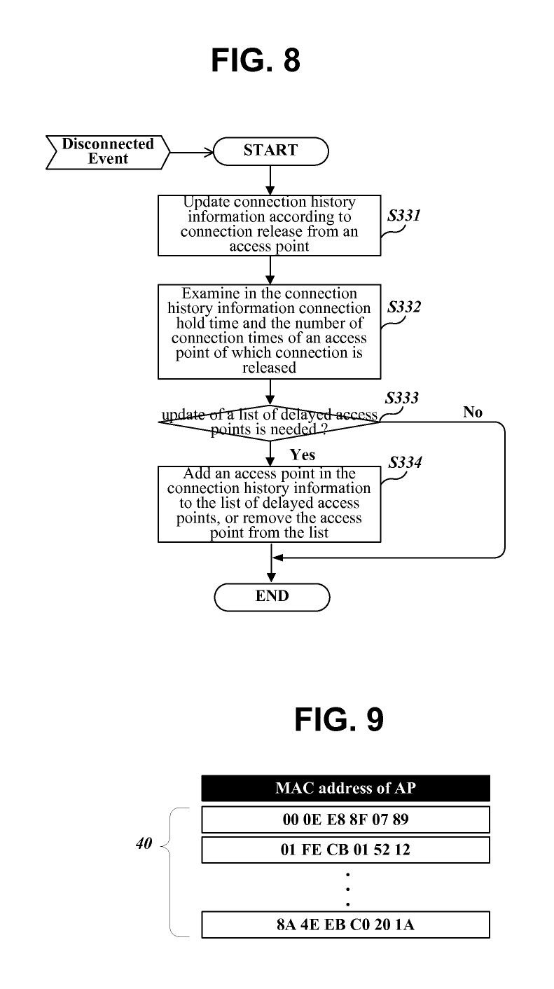

Also, when the connection control agent 110 is activated, the connection management unit 112 requests the operating system 100a to register the event of connection release from a Wi-Fi network. Upon receiving the registration request, the operating system 100a releases the connection IP address and notifies the connection management unit 112 requesting event registration of a connection release event when connection release from the Wi-Fi network is attempted or signal strength from an access point to which the operating system 100a is connected drops below a threshold level. Receiving the notification, the connection management unit 112 carries out a procedure of managing information required for connecting to an access point illustrated in FIG. 8. The procedure illustrated in FIG. 8 will be described in detail later.

As the timer is set up and a request for activating the timer is received, the network information acquisition unit 111 receives an event from the operating system 100a at each time-out of the timer. Receiving the event, the network information acquisition unit 111 searches a Wi-Fi network adjacent to the wireless communication terminal 100 for access points S301. To this purpose, the network information acquisition unit 111 requests and receives information about the state of the Wi-Fi network from the operating system 100a. The operating system 100a, in response to the request, controls the Wi-Fi modem 22a to physically search the Wi-Fi signal band; the operating system 100a then reads identification information of each /access point (r11 of FIG. 4) provided by the Wi-Fi modem 22a at the time of detecting a valid signal in the corresponding signal band, for example, a service set identifier (SSID), MAC address, received signal strength indicator (RSSI) of the access point, and so on; and returns the identification information to the network information acquisition unit 111. The network information acquisition unit 111 checks whether the returned information contains information about an access point S302; in the case of no information about an access point, the procedure of checking an access point in a Wi-Fi network as shown in FIG. 6 is terminated, whereas, if there exists information about an access point, existence of an available access point is notified to the connection management unit 112, S303. In the case of multiple access points, an access point showing the best signal strength is selected and is notified to the connection management unit 112. At this time, the total number of access points is delivered together, informing that one from among multiple access points has been selected. Similarly, at the time of notifying an available access point, RSSI of the access point can also be delivered.

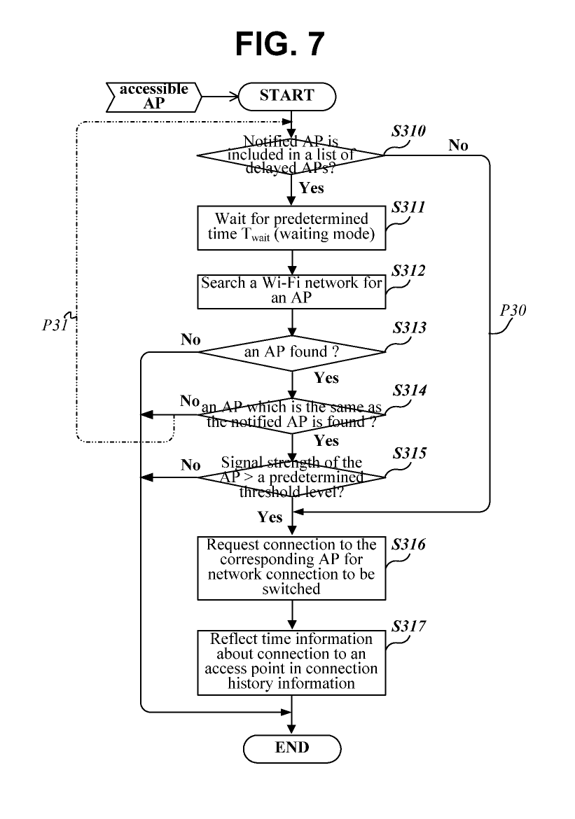

If notification about an available access point is received from the network information acquisition unit 111, the connection management unit 112 carries out a procedure of selective connection to a Wi-Fi network as shown in FIG. 7; first, it is checked whether the notified available access point belongs to a list of delayed access points managed by the connection management unit 112, S310. The list of access points corresponds to a list 40 of information with which each individual access point can be identified as shown in FIG. 9, for example, a list of MAC addresses of the corresponding access points; a procedure of registering identification information of an access point for the list will be described later. In case identification information of a currently notified access point does not belong to the list 40 of delayed access points, the connection management unit 112 requests the operating system 100a to connect the wireless communication terminal 100 to the Wi-Fi network S316 (in case the number of access points notified by the network information acquisition unit 111 is multiple, identification information of each access point is transmitted in response to the request). Since the wireless communication terminal 100 usually maintains a cellular network connection state by using an IP address for connection allocated by the cellular network, connection to the cellular network is released according to the request for connection to the Wi-Fi network and a procedure for connection switching to the Wi-Fi network is initiated. In case a single access point is notified to be available by the network information acquisition unit 111, a request for connecting to the Wi-Fi network can be accommodated by either requesting the operating system 100a for connection by designating a type of connection to the Wi-Fi network or requesting the operating system 100a to enable a function for searching the Wi-Fi network (for example, “auto-mode” can be set for access to the Wi-Fi network).

In case a currently detected access point is found not to belong to the list 40 of delayed access points, as described above, connection switching to the Wi-Fi network is not immediately carried out but after a predetermined operation, for example, re-search of the Wi-Fi network is carried out after a predetermined period of time T_{research}_{_{—}}ᵢₙₜ, connection switching to the Wi-Fi network may be carried out according to the search result. In this case, too, according to the technical principles and concept of the present invention, a time period required before the operation of connection switching is carried out (for example, T_{research}_{_{—}}ᵢₙₜ above) has to be shorter than a waiting time T_{wait} (the waiting time will be described in detail later) by which connection is delayed in case an access point belongs to the list 40 of delayed access points. In other words, in the procedure for selective connection to the Wi-Fi network as shown in FIG. 7, connection switching S316 to the Wi-Fi network through a path P30 intended for the case where a notified access point does not belong to the list 40 is carried out within a time period shorter than the waiting time T_{wait} adopted when the access point belongs to the list 40, preferably within a sufficiently short time period.

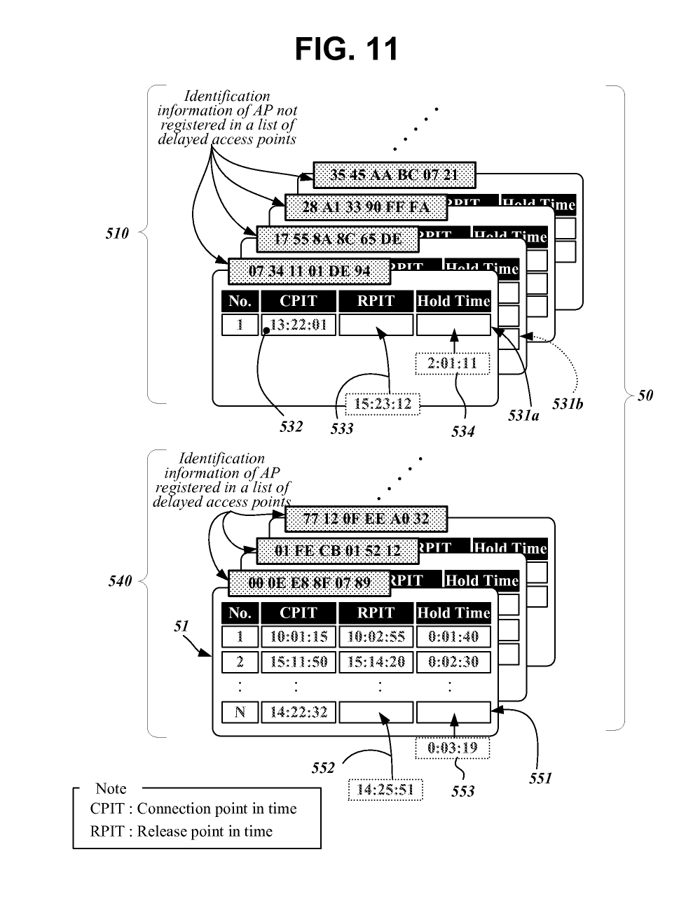

If the wireless communication terminal 100 is connected to an access point detected previously by the network information acquisition unit 111 in response to a request of the connection management unit 112 for the operating system 100a to perform connection switching to a Wi-Fi network as described above, the connection management unit 112 reflects time information about connection to the access point in the Wi-Fi network access history information 50 (hereinafter, it is called “connection history information” for short) configured according to the structure as shown in FIG. 11, S317. In case the wireless communication terminal 100 is connected to an access point not included in the list 40 of delayed access points, a progress information entry is put in the unregistered access point information area 510 within the history information 50 when the access point is reflected in the connection history information 50. At this time, the connection management unit 112 searches the unregistered access point information area 510 for identification information of a currently connected access point, for example, MAC address to enter the progress information entry for each access point as shown in FIG. 11; if no corresponding access point is found, a new unregistered access point item is generated and the progress information entry is put in the item 531a whereas, if an item corresponding to the access point is found, the progress information entry is put next to the last entry of the item 531b. Also, a number indicating the order of the progress information entry within the corresponding item is recorded at the front of the entry. In a different implementation, the total number of registered entries may be recorded in the corresponding access point item. As shown in FIG. 11, each progress information entry recorded in the connection history information 50 includes “connection time”, “release time”, and “holding time” field, and as described above, in the event that the wireless communication terminal 100 is connected to an arbitrary access point, a current time is consulted from the operating system 100a and is recorded as a field value for “connection time” 532. Once time information about connection to an access point is reflected in the connection history information 50, a value indicating an access point item (namely, an item about a currently connected access point) in which time information about a connection procedure is reflected and a value indicating an information area (namely, an information area of a unregistered access point) of the access point item are recorded in an index variable, terminating a procedure for selective connection to a Wi-Fi network as shown in FIG. 7.

Meanwhile, in case a currently detected access point, namely, an access point notified by the network information acquisition unit 111 is found in the list 40 of delayed access points S310, the connection management unit 112 makes the wireless communication terminal 100 wait for a predetermined waiting time T_{wait}, for example, 10, 15, or 20 seconds rather than directly attempt connection switching to a Wi-Fi network S311. In other words, a decision about whether to perform connection switching to a Wi-Fi network is delayed for a predetermined period of time. In this wait mode, other necessary functions are carried out but a procedure for connecting to the Wi-Fi network is suspended until the waiting time T_{wait} is passed. At this time, the connection management unit 112 specifies an access point notified by the network information acquisition unit 111 as a stopover access point. The other functions carried out in the wait mode can include a Wi-Fi network search. It should be noted, however, that information obtained as a result of the search is not used for determining whether to perform connection switching to the Wi-Fi network. The information, being used together with a result obtained from a search after the waiting time T_{wait} is elapsed, can be used for determining whether to perform connection switching of the wireless communication terminal 100 to the Wi-Fi network; however, connection switching to the Wi-Fi network is not determined solely from the search of the Wi-Fi network obtained during the waiting time T_{wait} while excluding the result obtained from a search after the waiting time T_{wait}. While the wait mode is maintained by the connection management unit 112, the wireless communication terminal 100 can be made to perform a search of the Wi-Fi network by another application, another process, or the operating system 100a. Therefore, the technical principles and concept of the present invention do not exclude a search of the Wi-Fi network performed by the wireless communication terminal 100 during a predetermined period of time; even if the search is carried out, whether to perform connection switching to the Wi-Fi network is eventually determined based on a result of searching the Wi-Fi network after a predetermined waiting time (a search result before the waiting time can also be used).

The reason of delaying connection to an access point registered in the list 40 of delayed access points is that the user carrying the wireless communication terminal 100 usually passes by those access points registered in the list 40 of delayed access points according to the concept and technical principles of the present invention. For example, access points registered in the list 40 of delayed access points may correspond to those access points installed around a station (or bus stop) where public transportation means (buses, subway cars, and so on) temporarily stop or those access points installed at an arbitrary place on a path along which the user moves on foot or by the using his or her car. A procedure of registering such access points in the list 40 of delayed access points will be described clearly with examples later.

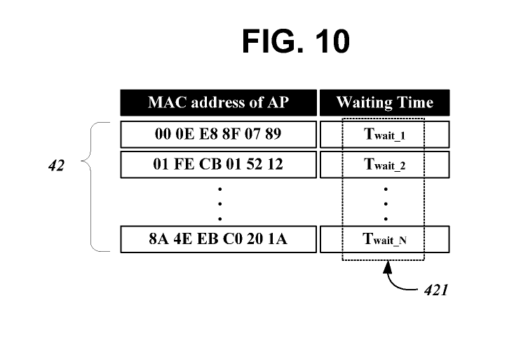

The waiting time T_{wait} for delayed connection to a Wi-Fi network may or may not use the same value for the entire list of delayed access points. Also, the waiting time T_{wait} may or may not always use a fixed value. In case the whole access points in the list do not use the same waiting time, a time value for delaying determination of connection is specified for each access point in the list of delayed access points as shown in FIG. 10 421. Of course, a group of access points may use the same time value in this case. A procedure of determining a waiting time for each access point will be described along with the description of registering an access point in the list 40, 42 of delayed access points. In the present embodiment, if identification information of an access point notified by the network information acquisition unit 111 belongs to the list 42 of delayed access points, a time value T_{wait} specified in accordance with the identification information is specified as the waiting time T_{wait}.

One example of using varying waiting time is a case where the waiting time is determined dynamically according to signal strength of a searched access point. In case the waiting time T_{wait} is determined dynamically, it can be determined according to a rule illustrated in FIG. 13. The determination rule for a waiting time illustrated as a graph in FIG. 13 is just a simple example; various kinds of rules not shown in this document can also be used as embodiments of the present invention as long as the rules follow the basic principle stating that the waiting time T_{wait} becomes shorter as signal strength of an access point notified as available from a search S302 conducted by the network information acquisition unit 111 gets higher. Higher signal strength indicates more closeness to an access point and also indicates a situation that the user intentionally approaches the access point to use a Wi-Fi network instead of passing by the corresponding access point as in a conventional situation, thereby making the waiting time relatively short.

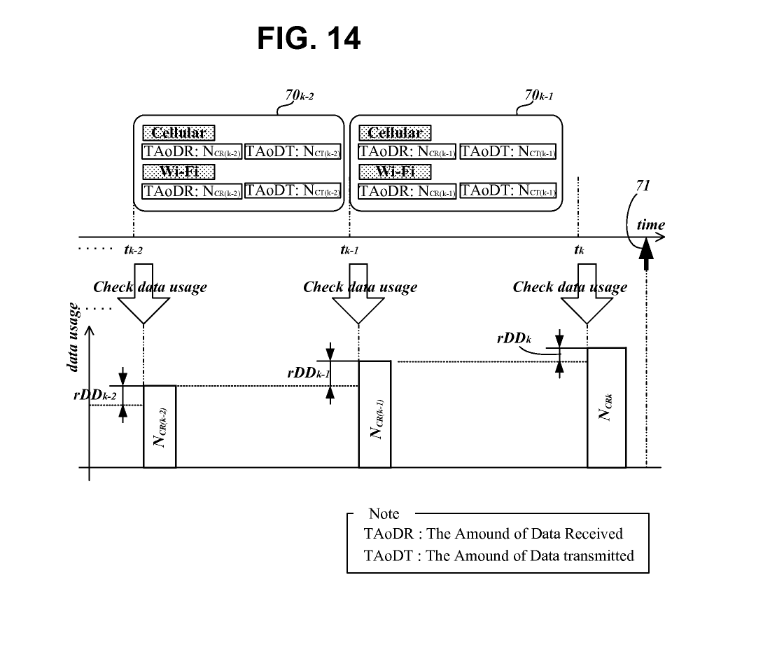

In one embodiment according to the present invention, the waiting time T_{wait} can be set dynamically according to the amount of data used by the wireless communication terminal 100. To this end, in the present invention, the connection management unit 112 repeatedly checks the amount of accumulated data used by the wireless communication terminal 100 for each communication network by requesting the amount of accumulated data used from the operating system 100a according to predetermined intervals. In the present invention, as shown in FIG. 14, the connection management unit 112 performs periodic operation of obtaining a data communication history (70ᵢ, i=. . . , k−2,k−1,k, . . . ), which is the information about cumulative data usage for each communication network, by requesting the data communication history from the operating system 100a and checking the amount of variation of received data of a cellular network (rDDᵢ, i=. . . , k−2,k−1,k . . . ) between data acquisition times (tᵢ, i=. . . ,k−2,k−1,k, . . .) from the obtained individual data communication histories 70i, namely, the amount of data usage between time intervals. The connection management unit 112 determines at the moment availability of an access point is notified 71 the waiting time T_{wait} according to the amount of data usage of the cellular network rDDₖ (or an average value of the amount of data usages (rDDⱼ, j=k−N,k−N+1, . . . ,k−1,k) previously obtained) already known to the connection management unit 112 and maintains a wait mode for the waiting time T_{wait}. The graph shown in FIG. 13 may be one example illustrating a rule with which the waiting time T_{wait} is determined according to the amount of data usage of the cellular network. At this time, the horizontal axis of the graph of FIG. 13 represents the amount of data usage. Other rules in addition to the one shown in the graph can also be employed. However, a basic principle must be followed: the more the amount of data usage of the cellular network becomes, the waiting time T_{wait} has to be made shorter. This principle is intended for increasing a probability that a load proportional to the amount of current data usage is transferred to a Wi-Fi network by searching the Wi-Fi network in a much shorter time period as the current load applied to the cellular network is increased.

In one embodiment according to the present invention, the waiting time T_{wait} can be determined dynamically according to a load imposed on a cellular network to which a wireless communication terminal is currently connected. In the present invention, the connection management unit 112 can receive information about a current load on the cellular network from an external, particular operating server. More specifically, the connection management unit 112 generates a request destined to the operating server in compliance with a communication protocol, for example, a HTTP request, by including position identification information providing a current position of the wireless communication terminal 100, for example, identification information of an access point notified by the network information acquisition unit 111 or identification information of a service area (or a base station) of a cellular network identified by the network information acquisition unit 111; the connection management unit 112 then requests the operating system 100a to transmit the HTTP request and in response to the request, the operating system 100a transmits the request compliant with communication protocol through communication resources (the cellular codec 21b or cellular modem 21a) installed in the cellular network for which a current IP address is set up; and the operating server checks the corresponding service area from the information about a current position included in the received request compliant with communication protocol (identification information of an access point or service area) and transmits information about a current load of the service area (for example, a value indicating one of several load states already classified) to the wireless communication terminal 100 in response to the received request. The connection management unit 112 receives the response information through the operating system 100a. The connection management unit 112, if load information included in the received response information is a value indicating a load state above a predetermined level, sets up the waiting time T_{wait} to be relatively short compared with the case where the value is below the predetermined level. It should be noted that the rule illustrated in FIG. 13 can still be used for determining a waiting time. In this case, the horizontal axis of the graph of

FIG. 13 represents the load level of a cellular network. The present embodiment, too, by making searching a Wi-Fi network performed in a much shorter time period as the load imposed on the corresponding service area of the cellular network is increased, intends to make the Wi-Fi network available as early as possible (in other words, to reduce traffic load from the cellular network as fast as possible).

As described in the embodiment above, when the connection management unit 112 provides the operating server with information providing a current position of the wireless communication terminal 100, the operating server provides information about a load state at the corresponding area and the connection management unit 112 determines the waiting time T_{wait} based on the information. Different from the above scheme, the operating server may check the load state of the area to which the corresponding mobile terminal belongs and directly determines waiting time in accordance with the load state and provides the waiting time for the connection management unit 112. In this case, the connection management unit 112 uses the provided waiting time as received. Similarly, independently of the mobile terminal's position, the operating server may determine the waiting time according to a time zone during which a request is generated and provide the waiting time for the connection management unit 112. In this case, it is not necessary to transmit information providing a current position of the wireless communication terminal 100 when the connection management unit 112 requests the waiting time from the operating server.

Among the various embodiments described above, after the connection management unit 112 enters a wait mode in which it waits until the waiting time T_{wait} is passed, which is determined according to any one of the methods or has a predetermined fixed value, the connection management unit 112 ignores notification of an available access point from the network information acquisition unit 111. In another implementation, the connection management unit 112 may request the network information acquisition unit 111 to deactivate a timer intended for carrying out the procedure of FIG. 6. Also, in one embodiment according to the present invention, if the connection management unit 112 enters the wait mode, it notifies the user of the event. More specifically, if the connection management unit 112 enters the wait mode, it notifies the UI processing unit 113 of the event and the UI processing unit 113, in response to the notification, requests the operating system 100a to display an indicator notifying of the wait mode (for example, an icon) and an input selector which allows “forced connection” (number information, selection button, combo box, and so on for selection) to be designated by the user on the display panel 25 or on a particular area thereof, for example, an alarm window.

As the indicator and the input selector (both of the two can be displayed by using a single icon) are displayed on the display panel 25, if the user recognizes the wait mode (a state where connection is on standby although an access point through which a Wi-Fi network can be accessed is available) and “forced connection” is designated by using the input selector through an appropriate input means (the keypad 26b or touch sensor 26a), the designation information is delivered to the operating system 100a through the input controller 26; and the operating system 100a provides the delivered designation information to the UI processing unit 113. Then the UI processing unit 113 confirms from the designation information that “forced connection” has been requested and notifies the connection management unit 112 of the request. The connection management unit 112, upon receiving the notification, immediately carries out the same operation as done when the wait mode is terminated irrespective of passing of the waiting time T_{wait}, which will be descried below.

In case the wait mode is terminated (in other words, in case a time period as long as the waiting time T_{wait} is passed), the connection management unit 112 is configured not to ignore the notification of an available access point from the network information acquisition unit 111 (or requests the network information acquisition unit 111 to activate the timer) and in case an indicator notifying of the wait mode and an input selector with which “forced connection” can be selected are displayed on the display panel 25, requests the UI processing unit 113 to remove the display from the display panel 25. In the same way as the network information acquisition unit 111 operates, the connection management unit 112 requests the operating system 100a to search for access points adjacent to the wireless communication terminal 100 again S312; if access points are found by the search S313, the connection management unit 112 checks whether an access point the same as the one specified previously as a destination access point belongs to the set of access points found S314. If the same access point is found, signal strength of the access point is checked; if the signal strength is above a predetermined level S315, the connection management unit 112 finally requests the operating system 100a to switch the access network of the wireless communication terminal 100 from a current cellular network to a Wi-Fi network S316.

According to the connection request, if the operating system 100a receives an IP address from the Wi-Fi network and establishes connection to the network and notifies of success of the connection switching, the connection management unit 112 is again set to the “manual mode” in case it was set to the “auto-mode” for accessing a Wi-Fi network. Also, as described above, time information about current connection is reflected in the connection history information 50, S317. In this case, however, the time information about current connection is reflected in the registered access point information area 540 of the connection history information 50 instead of a unregistered access point information area 510 in which a searched access point not belonging to the list of delayed access points 40, 42 is reflected after connection switching to the Wi-Fi network. In other words, identification information of a currently connected access point is searched for in the registered access point information area 540 of the connection history information 50 (if not found, an access point item of the corresponding identification information is generated) and a progress information entry including connection time is recoded in the access point item found (or generated) 551. Then a value indicating the access point item 51 in which the progress information entry is recorded and a value indicating an information area having the access point item (in other words, registered access point information area 540) are recorded in the index variable and the procedure for selective Wi-Fi network connection is terminated.

Meanwhile, if an access point is not found from a search S312 after the waiting time T_{wait} S313 or if none of access points found from the search is the same as a destination access point designated previously S314 or if an access point identical to the destination access point is found but signal strength of the access point checked by the search S312 is below a predetermined level specified as a reference S315, the connection management unit 112 terminates the procedure of selective connection to a Wi-Fi network instead of requesting connection switching to the Wi-Fi network. Since each individual case described above can be regarded to describe a situation where, after the waiting time T_{wait}, the user is already out of signal range of an access point (destination access point) notified as available by the network information acquisition unit 111 or the user is in the middle of getting out of the signal range thereof, there is very little chance that the user stays around the notified access point and uses a data service, which is the reason why connection switching to the access point is not carried out.

In another one embodiment of the present invention, in case none of access points found from the search S312 is the same as a destination access point designated previously S314, the procedure of selective connection to a Wi-Fi network may not be terminated. In the present embodiment, if the destination access point is not found from the search S312 but a different access point is found, signal strength (in the case of multiple access points, signal strength of an access point showing the highest value), signal strength of the different access point is checked and if the checked signal strength is below a predetermined threshold value, the procedure of selective connection to a Wi-Fi network is terminated whereas, if it is larger than the predetermined threshold value, it is checked whether the corresponding access point showing the signal strength larger than the predetermined threshold value is included in the list of delayed access points 40, 42 and operation according to the checking result is carried out P31. In other words, the connection management unit 112 waits again for the waiting time T_{wait} or for a predetermined time period of different length S311 (at this time, the corresponding access point is updated as a new destination access point), or it makes connection of the wireless communication terminal be switched immediately through the access point S316.

As described above, in case an available access point notified by the network information acquisition unit 111 (or an access point found after the notification) is included in the list of delayed access points 40, 42, the wireless communication terminal 100 does not switches connection to a Wi-Fi network if the corresponding access point is not found again after a delay due to the waiting time T_{wait} (in the embodiment of FIG. 10, waiting time specified for the corresponding access point is used for T_{wait}). Therefore, if the list of delayed access points 40, 42 contains such access points that are usually bypassed by the corresponding wireless communication terminal in the service area, the wireless communication terminal does not perform unnecessary connection switching from a cellular network to a Wi-Fi network for those access points.

It should be noted that even in the case where an access point belongs to the list of delayed access points 40, 42, the wireless communication terminal 100 may be connected to the access point depending on a situation as the access point is detected again from re-search S313. As described above, after the wireless communication terminal 100 is connected to an access point registered in the list of delayed access points 40, 42 or after the wireless communication terminal is connected to an access point without entering the wait mode as the corresponding access point not registered in the list of delayed access points 40, 42 is detected, if exchange of wireless signals with the access point connected is blocked due to movement of the wireless communication terminal 100 or if the user deliberately issues a request for releasing connection to the Wi-Fi network through a user interface, the operating system 100a releases connection to the access point and generates an event notifying of the connection release on an object registered for event notification (an application or a process). As described earlier, since the connection management unit 112 has already registered the notification in the operating system 100a regarding the connection release event, the event is notified to the connection management unit 112 and accordingly, the connection management unit 112 carries out a procedure of managing information for connection to the access point as shown in FIG. 8. In what follows, the procedure will be described in more detail.

If a connection release event is received, the connection management unit 112 records time information about the connection release in the connection history information 50, S331. To this purpose, the connection management unit 112 first checks values recorded in the index variable described above and determines that the notified connection release is associated with an access point item belonging to which information area of the connection history information 50. Then the connection management unit 112 records current time in the “release time” field of a last recorded progress information entry of the determined access point item. In case a currently released access point is the one not registered in the list of delayed access points 40, 42, the “release time” field of the last recorded progress information entry of the corresponding access point item belonging to an unregistered access point information area 510 is filled in 533 whereas, in case the currently released access point is the one belonging to the list of delayed access points 40, 42, the corresponding field of a last recorded progress information entry of the corresponding access point item in a registered access point information area 540 is filled in 552. Once current time is recorded in the “release time” field, a time difference 534 or 553 between the release time and the time recorded in the “connection time” field of the progress information entry is calculated and recorded in the “hold time” field of the corresponding entry 531a or 551. Only time information is recorded in the example shown in the figure; however, date information can also be recorded there.

As described above, once all the fields of the progress information entry are filled, the connection management unit 112 decides whether an update of the list of delayed access points 40, 42 is needed S332 by examining S332 the number of times the connection management unit 112 has been connected to the access point (in the example of FIG. 11, it is the same as the number of progress information entries) and the hold time of each connection. An update is needed for such a case where an access point needs to be added to the list of delayed access points 40, 42 in association with an access point item in the unregistered access point information area 510 of the connection history information 50 or an access point has to be removed from the list of delayed access points 40, 42 in association with an access point item in the registered access point information area 540. First, a case where an access point needs to be added to the list of delayed access points 40, 42 will be described.

If an access point released from connection corresponds to an access point item of the unregistered access point information area 510 of the list of delayed access points 40, 42 and the total number of connections is more than a predetermined threshold value (where an arbitrary number larger than or equal to 1 can be assigned to the threshold value) from the previous examination about the corresponding access point item, the connection management unit 112 compares hold time for each connection with a predetermined threshold value (for example, 2, 3, 5 minutes, and the like) and examines the ratio of the number of connection showing hold time longer than the predetermined threshold value, namely, the number of progress information entries to the total number of connections. If the ratio is smaller than or equal to a predetermined registration threshold value (for example, a particular ratio ranging from 0% to 50%) S333, the connection management unit 112 adds access point identification information of the corresponding access point item newly to the list of delayed access points 40, 42, S334. In this way, if a new item is added to the list of delayed access points 40, 42, the corresponding access point item in the unregistered access point information area 510 is removed from the access point history information 50.

A different method can be applied to an access point item the number of connections of which is larger than or equal to the predetermined threshold value to determine whether to add the corresponding access point to the list of delayed access points 40, 42. For example, an average value of time periods during which connection is held is calculated from the corresponding access point item and if the average value is smaller than or equal to a predetermined threshold value, access point identification information of the corresponding access point item can be added newly to the list of delayed access points 40, 42.

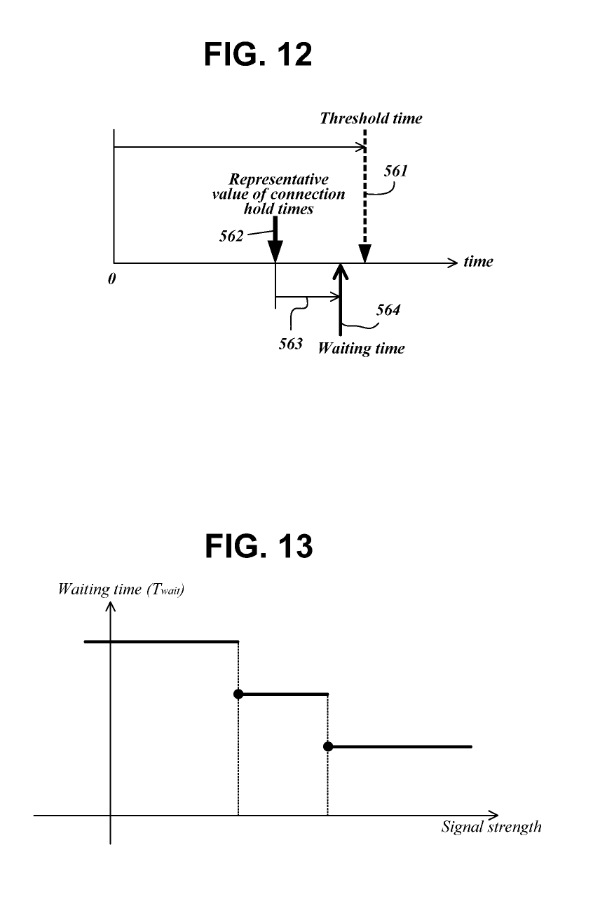

Meanwhile, in an embodiment of FIG. 10, when access point identification information is entered into the list of delayed access points 42, waiting time is also determined and recorded together. To this end, the connection management unit 112, as shown in FIG. 12, identifies from connection hold time of the corresponding access point determined to be added, connection hold time less than or equal to a predetermined threshold time 561 or a representative value 562 of the whole connection hold time (for example, an average, median, or maximum value); and determines the waiting time as a sum 564 of the representative value 562 and predetermined spare time 563 (for example, a fixed ratio of the representative value (for example, 25%) or a fixed time period (for example, 5 seconds)).

In one embodiment according to the present invention, the connection management unit 112, before adding access point identification information to the list of delayed access points 40, 42, delivers information about the access point to the UI processing unit 113, thus inquiring of the user, through the display panel 25, to set whether delayed connection to be conducted for the access point; based on a user's selection received through the UI processing unit 113 in response to the inquiry, the corresponding access point may or may not be registered in the list of delayed access points 40, 42. Although it is requested not to register an access point, the corresponding access point item may be removed from the unregistered access point information area 510 of the access history information 50. Also, in the present embodiment, to enable the user to recognize SSID of an access point through a screen provided by the UI processing unit 113, the connection management unit 112 manages an MAC address together with the SSID as access point identification information. In other words, each access point item of the connection history information 50 having a structure as shown in FIG. 11 records SSID of the access point, which is delivered to the UI processing unit 113 afterwards.

As described above, the hold time during which connection is maintained for an access point is short on average or from a statistical point of view. This fact indicates that although connection switching has been carried out without entering the wait mode since the access point is not included in the list of delayed access points 40, 42, more often than not the user passes by the access point instead of staying around the access point and using a data service. Therefore, for such an access point, to prevent generation of an undesired load of signaling signals upon a cellular network while a data service through the access point is not actually used or degradation of connectivity of the wireless communication terminal caused by immediate connection switching from the cellular network to a Wi-Fi network upon finding the corresponding access point, the corresponding access point is registered in the list of delayed access points 40, 42, thus delaying the connection and switching connection selectively to a Wi-Fi network depending on a situation after the delay.

Next, described will be a case for removing access point identification information from the list of delayed access points 40, 42.

If an access point released from connection corresponds to an access point item of the registered access point information area 540 of the list of delayed access points 40, 42 and the total number of connections is more than a predetermined threshold value (where an arbitrary number larger than or equal to 1 can be assigned to the threshold value) from the previous examination about the corresponding access point item S332, the connection management unit 112 compares hold time for each connection with a predetermined threshold value (for example, 2, 3, 5 minutes, and the like) and examines the ratio of the number of connection showing hold time longer than the predetermined threshold value, namely, the number of progress information entries to the total number of connections. If the ratio is smaller than or equal to a predetermined registration threshold value (for example, a particular ratio ranging from 50% to 100%) S333, the connection management unit 112 searches the list of delayed access points 40, 42 for access point identification information of the corresponding access point item and removes the identification information from the list S334. In this way, if the identification information is removed from the list of delayed access points 40, 42, the corresponding access point item in the registered access point information area 540 is removed from the access point history information 50.

A different method can be applied to an access point item the number of connections of which is larger than or equal to the predetermined threshold value to determine whether to remove the corresponding access point to the list of delayed access points 40, 42. For example, an average value of time periods during which connection is held is calculated from the corresponding access point item and if the average value is larger than or equal to a predetermined threshold value, access point identification information of the corresponding access point item can be removed from the list of delayed access points 40, 42.

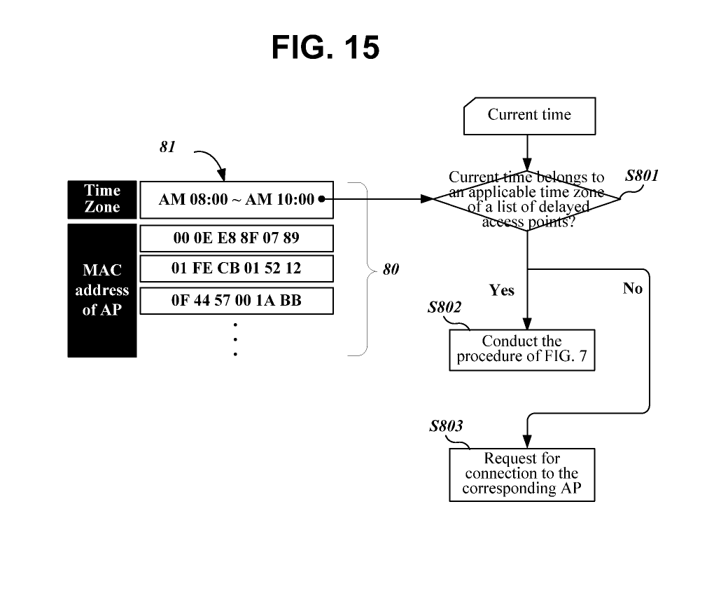

In one embodiment according to the present invention, the list of delayed access points functioning as described above is not always employed but only for a predetermined time zone. To this purpose, as shown in FIG. 15, the connection management unit 112 enters information 81 of a time zone to be applied for the list of delayed access points 80 into the list. The time zone may correspond to the one designated by the user through an operating environment set-up window provided by the access control agent 110 and the connection management unit 112 reads the designated time zone and enters it into the list of delayed time access points 80. In the present embodiment, the connection management unit 112, upon receiving notification of an available access point from the network information acquisition unit 111, checks current time and if the current time belongs to the time zone 81 set in the list of delayed access points 80, S801, carries out the procedure of selective connection to a Wi-Fi network described with reference to FIG. 7, S802; if the current time does not belong to the designated time zone 81, the connection management unit 112 carries out the procedure of connection switching to the corresponding access point S803. In case the current time does not belong to the time zone 81 set in the list of delayed access points 80, too, time information based on which connection to an arbitrary access point is established and released can be reflected in the connection history information 50 as described above. Although only one example of a time zone applied for the list of delayed access points 80 is shown in the figure, a plurality of different time zones separated from each other (for example, morning rush hour (AM 08:00˜AM 10:00) and evening rush hour (PM 6:00˜PM 8:00)) can also be designated and used.

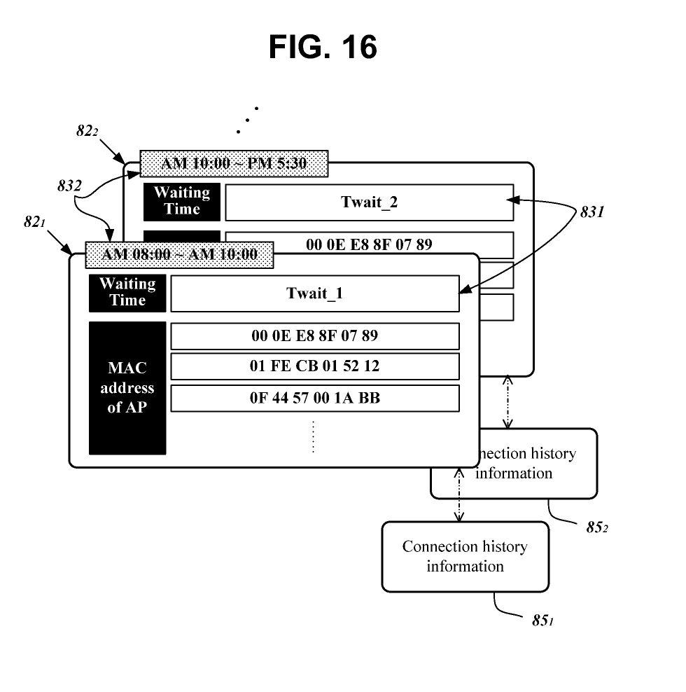

Also, in one embodiment according to the present invention, while time zones different from each other are assigned to a plurality of lists of access points, different waiting time T_{wait} can be assigned to at least two lists of delayed access points. In the present embodiment, as shown in FIG. 16, a time value 831, T_{wait}_{_{—}}ₖ, k=1,2, . . . , to be used as the waiting time T_{wait} described above is set for each of the corresponding lists of delayed access points 82, i=1,2, . . . . Among the lists of delayed access points, part or the whole of the access points can be registered in more than one list of delayed access points. Also, as described above, the time value (T_{wait}_{_{—}}ₖ, k=1,2, . . . ) to be applied as the waiting time with respect to a time zone 832 of each list (821, i=1,2, . . . ) of delayed access points can be specified through an operating environment set-up window of the connection control agent 110 by the user or predetermined in the connection management unit 112 for each time zone. In addition, the present embodiment employs a multiple number of connection history information (85₁, i=1,2, . . . ) described earlier for each individual list of delayed access points (82ᵢ, i=1,2, . . . ). To describe more specifically, if a time point at which the network information acquisition unit 111 notifies of an available access point is, for example, AM 09:30, it is checked whether identification information of the notified access point is registered in the list 821 of delayed access points associated with a time zone to which the time point belongs and according to the checking result, connection to a Wi-Fi network is carried out without entering the wait mode (in other case, connection to the Wi-Fi network may be carried out after wait mode of time value T_{wait}_{_{—}}ᵢ); when connection to the Wi-Fi network is made, information related to the connection is recorded in the connection history information 851 associated with the list of delayed access points 821, in other words, allocated to the corresponding time zone by generating a progress information entry. In case connection is released from the corresponding access point, information of the remaining fields (release time and hold time) in the progress information entry of the access history information 851 is completed. Next, in the same way as described above, it is checked for the corresponding access point item whether the list 821 of delayed access points needs to be updated. If it is decided that an update is needed, access point identification information is added to the list 821 of delayed access points associated with the connection history information 851, namely, designated to be applied for the same time zone or access point identification information registered in the list 821 of delayed access points is removed.

As in the embodiment described above, when a multiple number of lists of delayed access points use different waiting time, waiting time specified for a list of delayed access points used in a time zone in which movement of people is concentrated, for example, morning or evening rush hour can be set to be relatively longer than that of a list of delayed access points used for other time zones. A typical scenario for this situation is that an average time period during which people stay at a station due to congestion of public transportation is elongated; the different waiting time is thus introduced to prevent unnecessary connection switching to a Wi-Fi network due to such kind of situation.

In one embodiment according to the present invention, a list of delayed access points according to various embodiments operating as described above can be applied only for the case where a wireless communication terminal belongs to a particular service cell of a cellular network. In the present embodiment, in case the network information acquisition unit 111 finds an access point, before notifying the connection management unit 112 about identification information of the access point, requests and obtains identification information of a service cell in which the wireless communication terminal 100 is currently belongs from the operating system 100a. Upon receiving the request, the operating system 100a returns an identifier (hereinafter, it is called a “cell identifier”) of the latest service cell or base station tracked continuously from a radio signal according to a signal exchange protocol of the cellular network, the network information acquisition unit 111 notifies the connection management unit 112 of the returned cell identifier along with the identification information of the access point found. Then the connection management unit 112 searches a previously installed (or obtained by requesting from an external, particular server) list of cell identifiers for the notified cell identifier. If it is found that the notified cell identifier is included in the list of cell identifiers, the connection management unit 112 directly carries out the procedure of selective connection to a Wi-Fi network described with reference to FIG. 7; otherwise, the connection management unit 112 subsequently issues a request for the operating system 100a to make the wireless communication terminal 100 connect to the notified access point.

In case an access point for connection to a Wi-Fi network is not installed in the space of public transportation means such as a subway car in a big city, wireless communication terminals carried by people in the subway car can perform connection switching to the Wi-Fi network by connecting to an access point installed in a subway station building as the subway car passes by the subway station building; most of the time such connection switching causes a significant amount of signaling signal load on the cellular network because of a large number of passengers in the subway car, thereby degrading connectivity for a large number of mobile terminals. Therefore, delayed connection can be made to be performed selectively based on a list of delayed access points for this particular case. Since, in the case of a subway system, signals used for a cellular network are usually transmitted by employing relays along underground tracks, a single service cell is able to cover a considerably wide range. Therefore, if cell identifiers of service cells covered by a signal of a cellular network transmitted along a service route of the subway system are registered for the list of cell identifiers introduced in the embodiment described above, wireless communication terminals carried by people on board the subway train are enabled to perform the procedure of selective connection to a Wi-Fi network as described above through access points installed at subway station buildings.

In yet another embodiment according to the present invention, a list of delayed access points according to various embodiments operating as described above can be employed selectively depending on whether the list is designated for activation by an external, particular control server. For example, the connection management unit 112 periodically inquires the external control server of “activation of the list” and if the list is designated for activation in response to the inquiry, the procedure of selective connection to a Wi-Fi network based on a list of delayed access points as described above is carried out without modification, whereas, if an response to the inquiry indicates deactivation, the list of access points is not applied. In other words, if an access point of a Wi-Fi network is found to be available, the wireless communication terminal 100 is made to attempt connection thereto immediately. In the present embodiment, instead of inquiring the control server at regular intervals to check activation of a list of delayed access points, the control server can directly order the connection control agent 110 activation or deactivation of the list of delayed access points at required times. To this purpose, the connection management unit 112 gets confirmation of a currently allocated IP address for connection from the operation system 100a when the connection control agent 110 is initiated in the wireless communication terminal 100 and then reports to the control server on the confirmed IP address and a port number allocated to itself, which is repeated each time the IP address for connection is changed. The control server pushes into the connection management unit 112 a command message intended for designating activation or deactivation of a list of delayed access points at required times by using the reported IP address for connection and port number. In the present embodiment, if the connection management unit 112 inquires of the control server whether to activate the list, location identification information providing a current location of the mobile terminal as described above, for example, a cell identifier can be provided to the control server. Then the control server identifies the corresponding service cell from the location identification information and determines whether to activate a list of delayed access points and notifies the mobile terminals in that service cell about the determination result. For example, in case the amount of signaling signals communicated within a cellular network in that service cell is small, deactivation of the list of delayed access points is notified whereas activation thereof is notified otherwise.

In the embodiments according to the present invention described above, a list of delayed access points have been generated automatically and managed by the connection control agent 110. In another embodiment according to the present invention, the list of delayed access points can be managed manually by the user. For example, the user can directly enter access point identification information to be registered newly to a list of delayed access points; or access point identification information can be designated and removed from the list of delayed access points. In the present invention, if the user requests management of a list of delayed access points from the connection control agent 110, the UI processing unit 113, if necessary, switches to a full execution mode and provides a menu of “addition to or deletion from a list of delayed access points” on the display panel 25 through the operating system 100a. If the user selects “addition”, the UI processing unit provides a window by which access point identification information can be entered through the operating system 100a. If access point identification information entered through the window is received from the operating system 100a, the UI processing unit 113 delivers the identification information to the connection management unit 112 and requests addition of the identification information to the list of delayed access points. Upon receiving the request, the connection management unit 112 registers the identification information requested for addition in one or more lists of delayed access points.

If the user selects “deletion”, the UI processing unit 113 obtains information of a current list of delayed access points by requesting the information from the connection management unit 112 and displays the information of the list on a screen through the operating system 100a, thereby enabling the user to select identification information for deletion. In case there are multiple lists of delayed access points assigned to different time zones, the lists are displayed on the screen in the order of time sequence. If one or more identification information is selected from a list of delayed access points displayed on the screen through the operating system 100a, the UI processing unit 113 delivers the selected identification information to the connection management unit 112 and requests deletion of the selected identification information from the list. Upon receiving the request, the connection management unit 112 searches one or more lists of delayed access points for the identification information and removes the information from the corresponding list.

Meanwhile, the connection management unit 112 searches the unregistered access point information area of connection history information for access point identification information registered in the list of delayed access points according to the user's request and if an access point item of the identification information is found, the access point item is deleted from the unregistered access point information area. Also, the connection management unit 112 searches the registered access point information area of the connection history information for access point identification information removed from the list of access points according to the user's request and if an access point item of the identification information is found, the access point item is removed from the registered access point information area.

In one embodiment according to the present invention, information about access points recently accessed by the wireless communication terminal 100 can be provided visually for the user to easily add an access point to a list of delayed access points. In the present embodiment, the connection management unit 112, when entering progress information entry into the connection history information as described in FIG. 11, enters date and time information about the instant of connection, too. The UI processing unit 113, upon receiving a user request for addition of an access point, requests information about an unregistered access point from the list of delayed access points recently connected to the connection management unit 112 and the connection management unit 112, in response to the request, delivers to the UI processing unit 113 as much identification information as provided by a predetermined number of access points showing the most recent access time from among access point items in the unregistered access point information area of the access history information managed by the connection management unit 112. At this time, the access point identification information can include SSID and connection data and time can also be delivered. The UI processing unit 113, upon receiving such information, displays the information on the display panel 25 and thus enables the user to select one or more items from the displayed items. The UI processing unit 113 requests from the connection management unit 113 registration of access point identification information included in an item selected by the user into the list of delayed access points.

In the embodiments according to the present invention described above, the wireless communication terminal 100 generates a list of delayed access points; however, in different embodiments according to the present invention, a list of delayed access points can be generated by an external, particular server and provided to the wireless communication terminal. A list of delayed access points provided by a particular server can have a structure illustrated in FIG. 9, 10, 15, or 16. In the present embodiment, the connection management unit 112 of the connection control agent 110 uses the list of delayed access points in the same way as described above after requesting and receiving (or updating) it from the particular server at a particular time point; an example of the particular time point may be a specific time of a day (for example, AM 4:00) or when the connection management unit 112 is initiated in the wireless communication terminal 100.Similarly, the particular server may provide the list of delayed access points for the connection management unit 112 through the push manner as described in the embodiment above. In the present embodiment, the particular server can provide a list of access points containing access points requiring delayed connection for a particular area or route with respect to an area in which a wireless communication terminal is located. In such a case, as described above, the connection management unit 112 of the connection control agent 110 operating in the corresponding wireless communication terminal obtains location identification information providing a current location of the mobile terminal and request a list of access points by proving the information to the particular server; the particular server, based on the location identification information, constructs a list of access points requiring delayed connection within a predetermined distance or along a predetermined route and provides the list of access points to the connection management unit 112 in response to the request.

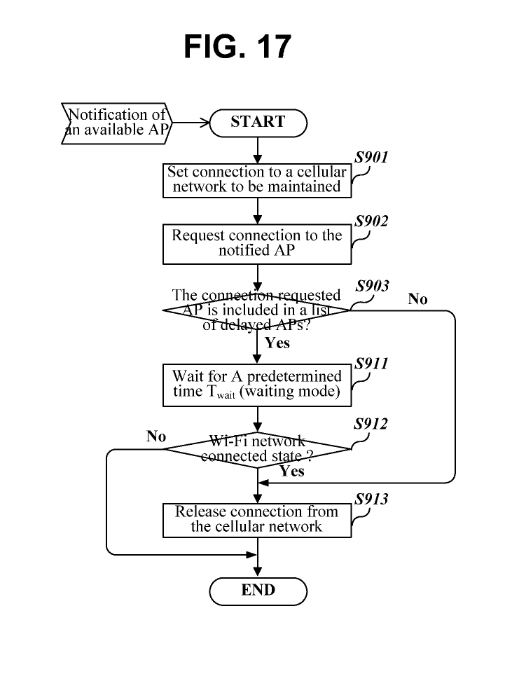

In the embodiments according to the present invention described above, if a searched access point is found to belong to a list of delayed access points, connection to the access point is determined after waiting time is passed. In other embodiments according to the present invention, even if a searched access point is found to belong to a list of delayed access points, connection switching from a cellular network to the searched access point is immediately carried out. A flow diagram illustrating a procedure of delaying connection release from a cellular network is shown in FIG. 17, which is carried out by the connection management unit 112 as described below.

The connection management unit 112, upon receiving notification of an available access point from the network information acquisition unit 111, takes steps for maintaining connection to a cellular network S901 and immediately requests connection to a Wi-Fi network from the operating system 100a S902. Due to the steps taken for maintaining the connection, even if the wireless communication terminal 100 is connected to a Wi-Fi network, connection to the cellular network is not released. Therefore, since a request for releasing connection is not transmitted to the cellular network, a procedure of connection release as shown in FIG. 2 is not carried out. The steps for maintaining connection can be carried out in various ways. For example, the connection management unit 112 may temporarily disable connection release from a cellular network if it is such a kind of function supported by the operating system 100a or the connection management unit 112 may change attributes of current connection to the cellular network into “special attributes” (in the case of “normal attributes” opposite to the special attributes, if the wireless communication terminal 100 is connected to another network, connection to the cellular network is released automatically) which enable connection to the cellular network to be maintained even when the wireless communication terminal 100 is connected to another network. If the wireless communication terminal 100 is connected to a Wi-Fi network, the connection management unit 112 enters a progress information entry into the connection history information in the same way as described in the previous embodiments.

The connection management unit 112 requests connection of the wireless communication terminal 100 to a Wi-Fi network and checks whether an access point requested for the connection is included in a list of delayed access points S903. If the access point is found in the list of delayed access points, the access point is made to stay in the wait mode during the waiting time T_{wait} determined by one of various other methods described earlier S911. If the access point is found not in the list of delayed access points, the connection management unit 112 requests release of connection to the cellular network from the operating system 100a, S913. For example, the connection management unit 112 enables connection release from the cellular network or recovers of attributes for the connection back to “normal attributes”. Due to the operation of the connection management unit 112 as described above, the operating system 100a transmits a request for connection release from the cellular network and accordingly, a procedure of releasing PDP context allocated for providing a service is carried out.

After the waiting time T_{wait} is passed, the connection management unit 112 requests network connection information from the operating system 100a and checks whether the wireless communication terminal 100 is still connected to a current Wi-Fi network S912. A communication network to which the wireless communication terminal 100 is connected can be known through network connection information returned by consulting the operating system 100a. Since the network connection information contains an IP address for connection, type of the connection (for example, a mobile communication network such as the 3G or 4G, Wi-Fi network, and so on) and the like in case the wireless communication terminal 100 is connected to a wireless communication network, a communication network to which the wireless communication terminal 100 is currently connected can be identified from the network connection information. If the wireless communication terminal 100 is still connected to the communication network after the waiting time T_{wait}, it can be interpreted that the user of the wireless communication terminal 100 still stays within a service cell of an access point notified by the network information acquisition unit 111. Then there may be a high chance that the user stays in the same place afterwards and based on this possibility, the connection management unit 112 requests the operating system 100a to release connection from the cellular network to which the wireless communication terminal 100 has been connected, thereby finally starting connection release S913. In other words, by starting the procedure as shown in FIG. 2, the connection management unit 112 prepares information resources allocated by the communication network to provide the wireless communication terminal 100 with a data service for another use, for example, PDP context.

If the wireless communication terminal 100 is not connected to a Wi-Fi network after the waiting time T_{wait} is passed, it can be interpreted that the wireless communication terminal 100 has already left a service cell of the notified access point and transitioned into a disconnection state by the operating system 100a; therefore, connection to the cellular network is maintained and the procedure of delaying connection release of FIG. 17 is terminated. At this time, attributes for connection to the cellular network may be changed from special attributes to normal attributes. In case the wireless communication terminal 100 enters a service area of an access point and then gets out of the corresponding service area before the waiting time T_{wait} is passed due to the operation according to delayed release from a cellular network performed by the connection management unit 112, switching to a Wi-Fi network may be carried out in the middle of operation but a procedure of release and re-connection to a cellular network is not carried out.

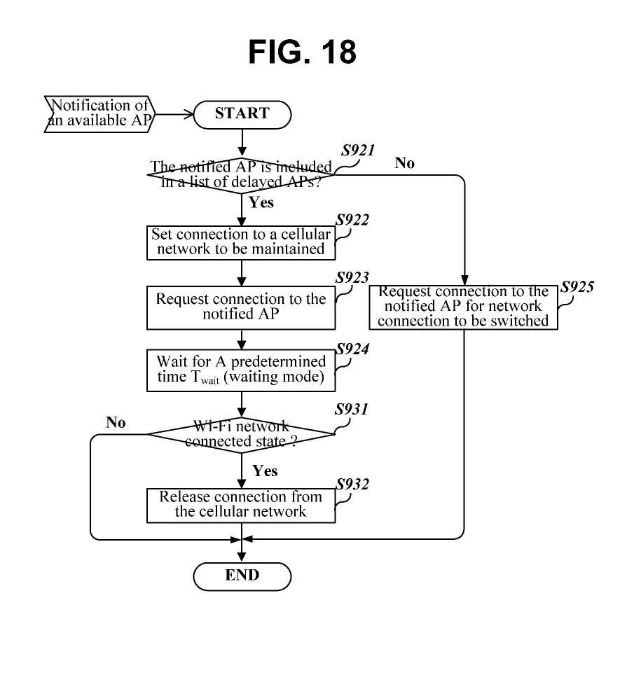

In the embodiment described above, registration of an access point in a list of delayed access points is checked after connection to a Wi-Fi network; in one embodiment according to the present invention, registration of an access point in a list of delayed access points is checked first. FIG. 18 shows an example illustrating a procedure of delaying connection release from a cellular network according to the present invention. As shown in FIG. 18, the connection management unit, upon receiving notification of an available access point from the network information acquisition unit 111, checks whether the notified access point is included in the list of delayed access points S921 and if it is found the notified access point is included in the list of delayed access point, the connection management unit 112 then takes steps needed for maintaining connection to the cellular network S922 and requests the operating system 100a to connect the wireless communication terminal 100 to the notified access point S923. Next, the connection management unit 112 proceeds to the wait mode S924 and procedures subsequent to the wait mode are the same as in the embodiment described with reference to FIG. 17. Meanwhile, if it is found that the notified access point is not included in the list of delayed access points S921, the connection management unit 112 requests the operating system 100a to switch connection of the wireless communication terminal 100 to the Wi-Fi network, S925. In this case, when the wireless communication terminal 100 is connected to an access point, the procedure of delaying connection release from a cellular network is carried out by the operating system 100a.

In the embodiments described with reference to FIGS. 17 and 18, connection state to a Wi-Fi network is checked after the waiting time T_{wait} is passed S912, S931. In another embodiment according to the present invention, signal strength of an access point to which the wireless communication terminal 100 has been connected previously can be checked. If the checked signal strength is larger than a predetermined threshold value, connection release from a cellular network is requested; if not, the procedure of delaying connection release is terminated.

In the same way as the embodiments described with reference to FIGS. 17 and 18, the connection management unit 112, upon receiving from the operating system 100a notification of release from an access point to which the wireless communication terminal 100 has been connected, the procedure of managing information for connecting to an access point as shown in FIG. 8 is carried out. In other words, a progress information entry within connection history information related to the released access point, where part of fields of the progress information entry is left unfilled, is now completed; if necessary, based on the number of connection times of an access point item to which the completed progress information entry belongs and hold time for the connection, the access point item is added to or removed from the list of delayed access points.

In the embodiments according to the present invention described above, if an access point is found and the access point is included in a list of delayed access points, determination on whether to connect the wireless communication terminal 100 to the access point (or determination on whether to release connection from a cellular network) is postponed until the waiting time is over. Different from the above, if an access point found is not included in a separate list of access points, determination on whether to connect the wireless communication terminal 100 to the access point (or determination on whether to release connection from the cellular network) is postponed until the waiting time is over whereas, if the access point is registered in the list of access points, the wireless communication terminal can be switched to a Wi-Fi network without incorporating the waiting time. In this case, the separate list of access points can be called a “list of fast processing access points” to reflect the purpose of the list. The operation of the connection control agent 110 described in various embodiments above which assume the use of a list of delayed access points can be directly applied to the case of using the list of “fast processing access points” and if necessary, the operation can be applied after being modified to accommodate the intended function of the list. For example, if it is found from the connection history information that connection hold time of an access point unregistered in the list of fast processing access points exceeds a predetermined threshold value, the access point is registered in the list of fast processing access points whereas, if it is found from the connection history information that connection hold time of an access point registered in the list of fast processing access points is smaller than a predetermined threshold value, the access point is removed from the list of fast processing access points.

The embodiments described above assume that a wireless communication terminal is connected to a cellular network when delayed connection to an access point of a Wi-Fi network found is determined based on a registration state of the access point in a list of access points. However, even if the wireless communication terminal is connected to the Wi-Fi network, various other methods can be applied to carry out the delayed connection selectively. For example, in case an access point for a Wi-Fi network is installed inside a public transportation vehicle, wireless communication terminals carried by passengers onboard the vehicle are connected to an access point inside the vehicle; if the vehicle passes by a station along its service route, the wireless communication terminals may search for an access point installed at the station. At this time, as described above, if delayed connection is carried out according as the searched access point is already registered in the list of delayed access points, since the access point installed at the station is unavailable as the vehicle passes by the corresponding station, unnecessary connection switching is not carried out. Therefore, connectivity of the wireless communication terminal is significantly improved compared with the prior art.

The embodiments according to the present invention appearing in this document assume a Wi-Fi network as an example of a high speed wireless communication network. However, the technical principles and concept of the present invention can also be implemented in a different type of network other than a Wi-Fi network. Independently of the employed name or signal exchange method to and from mobile terminals, in the case of a wireless communication network consisting of access points providing data services individually in the form of a wireless communication service zone having a limited service area smaller than the average size of service cells defined in a mobile communication network ensuring seamless communication (namely, handover) among service cells, all the embodiments of the present invention described above can be applied for connection switching between the wireless communication network and a mobile communication network or connection switching between access points in the wireless communication network.

Various embodiments of the present invention and methods introduced therein can be applied in various ways of selective combinations unless they are incompatible with each other.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

1. A wireless communication terminal capable of using a data service provided by a wireless communication network, comprising:
an information acquisition unit configured to search a wireless communication network for an available access point; and
a connection management unit, if the information acquisition unit discovers an available access point of the wireless communication network, configured to carry out a delayed selective connection switching operation or cause connection of the wireless communication terminal to be switched to the available access point, based on whether the access point is listed in a pre-specified access point list,
wherein the delayed selective connection switching operation comprises:
a first operation of re-searching the wireless communication network after a predetermined waiting time; and
a second operation of keeping the wireless communication terminal in a current connection state in case it is found from the re-searching that the access point is unavailable, and of causing connection of the wireless communication terminal to be switched to the access point in case the access point is found to be available.

2. The wireless communication terminal of claim 1, wherein the connection management unit is configured to carry out the delayed selective connection switching operation if the access point is registered in the access point list.

3. The wireless communication terminal of claim 1, wherein the connection management unit is configured to carry out the delayed selective connection switching operation if the access point is not registered in the access point list.

4. The wireless communication terminal of claim 1, wherein the connection management unit is configured to set the waiting time by using a time value assigned to the access point identified by the information acquisition unit.

5. The wireless communication terminal of claim 1, wherein the connection management unit is configured to set the waiting time in such a manner that the waiting time is shorter as signal strength of the access point is higher, the signal strength being detected by the information acquisition unit.

6. The wireless communication terminal of claim 1, wherein the connection management unit is further configured to obtain data usage for another wireless communication network of the wireless communication terminal, and to set the waiting time in such a manner that the waiting time is shorter as the data usage is greater.

7. The wireless communication terminal of claim 1, wherein the connection management unit is further configured to obtain from an external server information indicating a current load on a service area of another wireless communication network, the service area being where the wireless communication terminal is located, and to set the waiting time in such a manner that the waiting time is shorter as the current load indicated by the obtained information is higher.

8. The wireless communication terminal of claim 1, wherein the connection management unit is further configured to obtain from an external server a time value for delaying determination on whether to connect, and to set the obtained time value to the waiting time, the time value being to be applied for current time or a service area of another wireless communication network, wherein the service area is where the wireless communication terminal is located.

9. The wireless communication terminal of claim 1, wherein the delayed selective connection switching operation further comprises:
an operation of constructing display of the wireless communication terminal, once the predetermined waiting time gets started, through which a user requests a connection to the wireless communication network; and
an operation of switching connection of the wireless communication terminal to the wireless communication network regardless of whether the waiting time expires, if a connection request is made by a user.

10. The wireless communication terminal of claim 1, wherein the connection management unit, while carrying out the second operation, determines that the access point is unavailable if the access point is not found from the re-searching or shows signal strength not greater than a predetermined threshold level.

11. The wireless communication terminal of claim 1, wherein the delayed selective connection switching operation further comprises
an operation of, if another access point rather than the access point showing signal strength greater than a predetermined threshold level is found from the re-searching, checking whether the another access point is registered in the access point list, and according to the checking result, delaying determination on whether to connect to the another access point or switching connection of the wireless communication terminal from another wireless communication network to the another access point.

12. The wireless communication terminal of claim 1, wherein the connection management unit is configured to further conduct, if the wireless communication terminal is released from a one access point of the wireless communication network after being connected thereto, acquiring connection hold time with the one access point and registering the one access point in the access point list or removing the one access point from the access point list, based on information computed from one or more connection hold times acquired for the one access point.

13.-15. (canceled)

16. The wireless communication terminal of claim 1, wherein the connection management unit is configured to set up the access point list by receiving the access point list from an external server after providing the external server with location information from which a location of the wireless communication terminal is identifiable.

19. The wireless communication terminal of claim 1, wherein the connection management unit is configured to carry out the delayed selective connection switching operation or cause connection to be switched to the access point based on whether the access point is listed in the access point list, only if present time pertains to an applicable time zone of the access point list.

20. (canceled)

21. The wireless communication terminal of claim 1, wherein the connection management unit is configured to:
carry out the delayed selective connection switching operation or cause connection to be switched to the access point based on whether the access point is listed in the access point list in case application of the access point list is demanded by an external server; and
switch connection of the wireless communication terminal from another wireless communication network to the access point regardless of whether the access point is listed in the access point list in case application of the access point list is not demanded.

22. (canceled)

23. The wireless communication terminal of claim 1, wherein the information acquisition unit is further configured to obtain identification information of a service cell of another wireless communication network, the service cell being where the wireless communication terminal is located, and
wherein the connection management unit is configured to:
carry out the delayed selective connection switching operation or cause connection to be switched to the access point based on whether the access point is listed in the access point list in case identification information of a recent service cell obtained by the information acquisition unit is included in a predetermined cell list; and
switch connection of the wireless communication terminal from another wireless communication network to the access point regardless of whether the access point is listed in the access point list in case the identification information of the recent service cell is not included in the predetermined cell list.

24. (canceled)

25. The wireless communication terminal of claim 1, wherein the information acquisition unit and the connection management unit are configured to operate while a predetermined condition is met and remain in an idle state while the condition is not met, the predetermined condition including:
a condition on whether present time belongs to a predetermined time zone;
a condition on whether the wireless communication terminal is in a screen unlock state; or
a condition on whether a mode for accessing the wireless communication network set in the wireless communication terminal is an auto-mode designated by a user.

26. (canceled)

27. The wireless communication terminal of claim 1, wherein the wireless communication network is a network constituted by access points distributed and individually providing a data service in each service cell that covers an area narrower than an average size of a single service cell of another wireless communication network supporting a mobile communication.

28.-30. (canceled)

31. A machine-implemented method for managing connection to a plurality of wireless communication networks in a wireless communication terminal, comprising:
a first step of searching a wireless communication network;
a second step of checking whether an access point of the wireless communication network is listed in a pre-specified access point list if the access point is found to be available from the searching; and
a third step of re-searching the wireless communication network after a predetermined waiting time if a condition that the access point is or is not listed in the access point list is satisfied, and either keeping the wireless communication terminal in a current connection state in case it is found from the re-searching that the access point is unavailable, or causing connection of the wireless communication terminal to be switched to the access point in case the access point is found to be available.

32. (canceled)

33. An apparatus for providing programs stored in a storage to other devices, comprising:
communication means being capable of transceiving data through communication with an outside entity; and
storing means storing an application to be run on a wireless communication terminal, the application being transmitted or received through the communication means,
wherein the application includes program codes to accomplish functions, in case of being run on the wireless communication terminal, that comprise:
searching a wireless communication network for an available access point; and
in case an access point of the wireless communication network is found to be available, carrying out a delayed selective connection switching operation or causing connection of the wireless communication terminal to be switched from another wireless communication network to the access point, based on whether the access point is listed in a pre-specified access point list,
wherein the delayed selective connection switching operation comprises:
re-searching the wireless communication network after a predetermined waiting time; and
either keeping the wireless communication terminal in a current connection state in case it is found from the re-searching that the access point is unavailable, or causing connection of the wireless communication terminal to be switched to the access point in case the access point is found to be available.
